(19) United States
(12) Patent Application Publication
(10) Pub. No.: US 2014/0347479 A1
(43) Pub. Date: Nov. 27, 2014

(54) Methods, Systems, Apparatuses, Circuits and Associated Computer Executable Code for Video Based Subject Characterization, Categorization, Identification, Tracking, Monitoring and/or Presence Response

(71) Applicant: Dor Givon, Tel Aviv (IL)

(72) Inventor: Dor Givon, Tel Aviv (IL)

(21) Appl. No.: 14/341,936

(22) Filed: Jul. 28, 2014

Related U.S. Application Data
(63) Continuation-in-part of application No. 14/128,710.
(60) Provisional application No. 61/869,109, filed on Aug. 23, 2013.
(60) Provisional application No. 61/559,090, filed on Nov. 13, 2011.

(51) Int. Cl. G06K 9/00; H04N 7/18

(52) U.S. Cl. CPC G06K 9/00288; G06K 9/00355; H04N 7/183
USPC 348/143; 382/116

(57) ABSTRACT

The present invention includes methods, systems, apparatuses, circuits and associated computer executable code for providing video based subject characterization, categorization, identification, tracking, monitoring, authentication and/or presence response. According to some embodiments, there may be provided one or more Image Based Biometric Extrapolation (IBBE) methods, systems and apparatuses adapted to extrapolate static and/or dynamic biometric parameters of one or more subjects, from one or more images or video segments including the subjects. According to some embodiments, extrapolated biometric parameters of subjects may be used to identify, track/monitor and/or authenticate the subjects. According to further embodiments, extrapolated biometric parameters may be used to determine physical positions of subjects and may further be used to identify one or more subjects exhibiting suspicious behavior based on their physical positions.

### PRIORITY AND CONTINUITY CLAIMS

The present application claims priority from U.S. Provisional Patent Application No. 61/869,109, filed by the inventors of the present invention, titled “METHOD, SYSTEM AND APPARATUS FOR BIOMETRIC BODY RECOGNITION AND IDENTIFICATION”, filed on Aug. 23, 2013;

The present application is a continuation in part of U.S. patent application Ser. No. 14/128,710, filed by the inventor of the present invention, titled “Methods Systems Apparatuses Circuits and Associated Computer Executable Code for Video Based Subject Characterization, Categorization, Identification and/or Presence Response”, filed on Dec. 23, 2013;

U.S. patent application Ser. No. 14/128,710 is a U.S. National Stage application of International Application PCT/IL2012/050562, filed on Dec. 31, 2012 by the inventor of the present application and titled: “Methods Systems Apparatuses Circuits and Associated Computer Executable Code for Video Based Subject Characterization, Categorization, Identification and/or Presence Response”; International Application PCT/IL2012/050562 claims the benefit of U.S. Provisional Application No. 61/559,090, filed on Nov. 13, 2011;

all of the aforementioned applications are hereby incorporated herein by reference in their entirety.

### FIELD OF THE INVENTION

The present invention relates generally to the field of computing, human-machine interfacing, surveillance, security, media and automated control systems. More specifically, the present invention relates to methods, systems, apparatuses, circuits and associated computer executable code for providing video based subject characterization, categorization, identification, tracking, monitoring and/or presence response.

### BACKGROUND

Video based observation of human subjects (subjects) dates back to the 1940's. Computer vision is a field that includes methods for acquiring, processing, analyzing, and understanding images and, in general, high-dimensional data from the real world in order to produce numerical or symbolic information. Image understanding can be seen as the disentangling of symbolic information from image data using models constructed with the aid of geometry, physics, statistics, and learning theory. Applications of computer vision range from tasks such as industrial machine vision systems which can inspect bottles speeding by on a production line, to research into artificial intelligence and computers or robots that can comprehend the world around them. Computer vision and/or derivatives thereof may also be used as part of video based human machine interfacing systems which provide users the ability to control or interact with computerized devices by gesturing while in line-of-sight of a video camera associated with the computerized device. Computer vision and/or derivatives thereof may further be used as part of video surveillance based security systems able to identify individuals and optionally to track and/or characterize their activity within a video feed or recording.

Computerized and dynamic control of various aspects and devices associated with a home, premises, facility, perimeter and/or any type of location is desirable. It is further desirable to provide subject specific computerized or automated control of various aspects and devices associated with a home, premises, facility, perimeter and/or any other type of location, such that control of the device or aspect is responsive to an identity or characteristic of a subject or subjects at or in proximity of the home, premises, facility, perimeter and/or any other type of location. It is yet further desirable to provide subject specific computerized or automated control of various security devices associated with a home, premises, facility, perimeter and/or any type of location, such that control or state of the security device is responsive to an identity or characteristic of a subject or subjects at or in proximity of the home, premises, facility, perimeter and/or any other type of location. It is also desirable to monitor and track subjects efficiently in areas where large volumes of people are present and in motion.

### SUMMARY OF THE INVENTION

### Definitions

### Access Authorization:

Permission to access a resource is called authorization. The act of accessing may mean consuming, entering, or using it.

### Access Control:

Access control is the selective restriction of access to a place or other resource. This might be physical, as with doors, gates, etc. or logical when accessing virtual resources. Locks and login credentials are two analogous mechanisms of access control.

### Authenticating Information:

There are three types (factors) of authenticating information:

Something the user knows, e.g. a password, pass-phrase or PIN.

Something the user has, such as smart card.

Something the user is, such as fingerprint, verified by biometric measurement.

### Behavioral Analytics:

Behavioral Analytics is a subset of business analytics that focuses on how and why users of eCommerce platforms, online games, & web applications behave. Behavioral analytics utilizes user data captured while the web application, game, or website is in use by analytic platforms. The data points are then compiled and analyzed, looking at the timeline progression from when a user first entered the platform. Behavioral analysis allows future actions and trends to be predicted based on all the data collected.

### Behavioral Biometric:

Behavioral biometric is based on a behavioral trait of an individual. Examples of behavioral biometrics may include speech patterns, signatures and keystrokes, gait, facial (to an extent) etc. Contrary to physical biometrics, it considers not only the physical traits of the subject, but rather the way it uses his/her body to complete different tasks.

### Biometrics:

Biometrics (or biometric authentication) refers to the identification of humans by their characteristics or traits. Biometric identifiers are the distinctive, measurable characteristics used to label and describe individuals. Biometric identifiers are often categorized as physiological versus behavioral characteristics.

### Biometric Parameters:

Biometric parameters are the values of measured physical characteristics of an individual. Biometric parameters can be divided into Static Biometric parameters and Dynamic Biometric parameters, wherein static biometric parameters are values of dimensions or other physical characteristics of physical elements of the individual unrelated to movement (e.g. height, weight, eye color, hand size and shape, etc.), whereas dynamic biometric parameters are values of dimensions, movements and ratios of movements of physical elements of an individual during performance of different physical movements (e.g. walking speed, ration of limb movements when walking, speed of arm movement when throwing a rock, etc.)

### Eigenfaces:

A set of eigenvectors used in the computer vision problem of human face recognition. This is used in biometric identification and classification of human subjects.

### Electronic Access Control Systems (EACS):

Electronic access control systems are systems using one or more technologies, for managing and granting and recording access authorizations to secured resources. Technologies which may be found in such systems include biometrics, Radio Frequency ID (RFID), secured keypads, etc.

### Extreme Motion:

Extreme Motion is a unique motion capture engine, developed by Extreme Reality ltd., which extracts the 3D position of the user in front of a regular camera in every frame and creates a real time 3D model of the user, represented by its joints XYZ coordinates. This model is then analyzed and gestures are extracted according to skeleton position and/or trajectories. Extreme Motion is the core technology behind the entire line of products offered by Extreme Reality ltd., including those discussed in this document.

### Gait:

Gait is defined as a person's manner of walking.

### Multi-Factor Authentication:

A security system where more than one form of authentication is used such as something you know (password), something you have (smart card), and something you are (biometric technology). The combination of these three security systems provides a high degree of security and convenience, which ensures confidentiality of personal information. This is superior to traditional passwords/PINS as these are easily guessed, forgotten or copied. Multi-factor authentication also includes biometric technology that uses biological characteristics or features, which are inseparable from a person; therefore, reducing the threat of loss or theft.

### Multimodal Biometric System:

Multimodal biometric systems use multiple biometric inputs to overcome the limitations of uni-modal biometric systems. This approach is targeted at contending with a variety of problems such as noisy data, intra-class variations, restricted degrees of freedom, non-universality, spoof attacks, and unacceptable error rates. Some of these limitations can be addressed by deploying multimodal biometric systems that integrate the evidence presented by multiple sources of information. Multimodal biometric systems overcome some of these problems by consolidating the evidence obtained from different sources, which may be multiple sensors for the same biometric, multiple instances of the same biometric, multiple snapshots of the same biometric, multiple representations and matching algorithms for the same biometric, or multiple biometric traits.

### Physical Biometrics:

Physical biometric is based on a physical trait of an individual. Examples of physical biometrics include fingerprints, hand geometry, retinal scans, and DNA. Contrary to behavioral biometrics, the physical approach considers only physical traits of the subject and not the way they are used.

### Video Surveillance:

Video surveillance is observation from a distance by means of electronic equipment (such as CCTV cameras), for the purpose of the monitoring of the behavior, activities, or other changing information, usually of people for the purpose of influencing, managing, directing, or protecting. Surveillance can be the observation of individuals or groups by government or commercial organizations, as well as for domestic use.

The present invention includes methods, systems, apparatuses, circuits and associated computer executable code for providing video based subject characterization, categorization, identification, recognition, tracking, monitoring, authentication and/or presence response. According to some embodiments, there may be provided one or more Image Based Biometric Extrapolation (IBBE) methods, systems and apparatuses adapted to extrapolate static and/or dynamic biometric parameters of one or more subjects, from one or more images or video segments including the subjects. According to some embodiments, extrapolated biometric parameters of subjects may be used to identify, recognize, track/monitor and/or authenticate the subjects. According to further embodiments, extrapolated biometric parameters may be used to determine physical positions of subjects and may further be used to identify one or more subjects exhibiting suspicious behavior based on their physical positions.
For the sake of convenience and clarity, the following description refers to human subjects. It should be understood, however, that the teachings and descriptions provided herein may equally be implemented in relation to other subjects (e.g. animals in a zoo) and, therefore, should be considered to include such implementations, with the necessary modifications.

According to some embodiments, biometric parameters may be extrapolated from images and/or video segments. The images and/or video segments may be acquired by one or more native image sensors of the system and/or may be received from third parties. Accordingly, according to some embodiments, there may provided one or more video/image acquisition sub-systems which may include cameras, video circuits and ports, and which may be adapted to capture one or more images/videos of subjects (e.g. person, adult, child, etc.). Furthermore, according to further embodiments, there may be provided one or more interfaces adapted to receive images and/or video data from third party image/video sensors and/or image/video processing systems. Third party data may be analyzed in conjunction or separately from image/video data received from native video/image acquisition sub-systems. The one or more video acquisition sub-systems may be integral or otherwise functionally associated with a video analytics sub-system, which video analytics sub-system may include various image processing modules, logic and circuits, and which may be adapted to extract, extrapolate or estimate from the images/videos biological parameters of subjects appearing in the images/video, static and/or dynamic, such as: height, width, volume, limb sizes, ratio of limb sizes, ratio of limb to torso sizes, limb/head shape, heights of different body parts during motion (e.g. max/min head heights when walking) or change of heights during motion, angular or distantial range of motion between different limbs and limb parts, angular or distantial range of motion between limb parts and torso or other body parts, head size, head movements, movement parameters of body parts when performing certain movements (e.g. parameters of hand motions when waving hello), hair color and configuration, facial features, shape and dimensions of specific body parts (e.g. ear shape and/or dimensions), distinguishing marks, clothing type and arrangement, unique wearable accessories, and so on. The extracted subject features may be analyzed and characterized/quantified to generate one or more subject indicators or subject biometric parameters which may include biometric parameters indicative of the subject's: (1) age, (2) gender, (3) ethnicity, (4) demographic, (5) physical attributes, (6) motion attributes, (7) physical condition, (8) mental state, (9) behavioral characteristics; (10) current intention(s) and/or (11) any other biometric parameters. Some indicators/biometric-parameters or sets of indicators/biometric-parameters derived from dynamic (motion) features of the subject may include body part motion profiles, combinations of body part motion profiles and derivative thereof including motion frequency coefficients and amplitudes.

According to some embodiments, biological parameters of subjects may be extrapolated from images by first correlating one or more skeletal models (2D or 3D) to the subjects. Based on a correlation of a skeletal model, dimensions and relations of body elements may be extrapolated. Further, based on a correlated skeletal model of a subject, body elements of a subject may be tracked to extrapolate motion parameters of the body elements and relations between them. A description of methods and systems for correlating skeletal models to subjects appearing in images is provided in U.S. Pat. No. 8,114,172, titled “SYSTEM AND METHOD FOR 3D SPACE-DIMENSION BASED IMAGE PROCESSING”, which is hereby incorporated into the present application in its entirety. Further, a correlation of a skeletal model to a subject in one or more images of a sequence may then be used to correlate the model to previous/future images in the sequence. According to further embodiments, skeletal model correlation and tracking may be joint based. In other words, a skeletal model may be correlated to an individual by correlating the locations and angles of the joints of the model to the joints of the individual. Accordingly, tracking of body parts of an individual and their motion may be performed by tracking the locations, positions and angles of the joints during the motion. Further, in relation to the description below, it should be understood that all descriptions relating to parameters of body parts and their motions may equally relate to parameters of joints and their motion, such that a portion or all of the analysis described herein may be performed entirely or partially based on joint identification, modeling and tracking alone.

A Subject Identification/Recognition/Categorization/Tracking/Monitoring/Authentication Sub-System may be comprised of modules, logic and circuits adapted to receive the extracted subject indicators/biometric-parameters, access an indicators/biometric-parameter reference database of subject indicators/biometric-parameters, and to either identify and/or categorize the subject. The identification/categorization sub-system may attempt to correlate the received subject indicators/biometric-parameters with reference subject/category indicators/biometric-parameters in the indicators/biometric-parameter reference database and/or may store received subject indicators/biometric-parameters for future reference. The reference subject indicators/biometric-parameters stored in the reference database may be associated with either a specific subject (e.g. individual by the name of Dor Givon) or with one or more groups, types or categories of subjects (e.g. Male, Asian, Adult, Men who previously passed by entrance X, etc.).

Correlation between a set of received subject indicators/biometric-parameters and reference indicators/biometric-parameters stored on the reference database may be absolute or partial. In certain situation, the set of subject indicators/biometric-parameters received for a subject (individual) being tracked may be smaller than the set of reference indicators/biometric-parameters stored for that subject in the reference database. In such an event, a partial match between the received indicators/biometric-parameters and the reference indicators/biometric-parameters may suffice for an identification, authentication, monitoring or categorization (optionally: only as long as the match between corresponding indicators is sufficiently high). In other cases, the set of subject indicators/biometric-parameters received for a subject (individual) being tracked may be larger than the set of reference indicators/biometric-parameters stored for that subject in the reference database. In such an event, once a match between the received indicators/biometric-parameters and the reference indicators/biometric-parameters is made (optionally: only when a match between corresponding indicators/biometric-parameters is sufficiently high) and the individual subject is identified, that subject's records in the reference indicators/biometric-parameters database may be updated to include the new and/or updated subject indicators/biometric-parameters received from the analytics sub-system. According to further embodiments, certain types of indicators/biometric-parameters may receive different weights in correlation, such that, for example, a correlated physical height indicator/biometric-parameter may be factored more heavily than a clothing related indicator/biometric-parameter. Furthermore, one or more indicator/biometric-parameter type correlations may allow for deviations in parameters which will still be considered matching in degrees which may vary from indicator/biometric-parameter type to indicator/biometric-parameter type (for example, deviations in walking speed of less than 10% may still be considered matches while deviations of 10% in height will not). Yet further, allowed deviations in parameters may vary from individual to individual, possibly based on a degree of deviation determined when obtaining a reference profile for the individual. For example, it may be determined that individual x varies the degree of motion of his arms as much as 20% during walking whereas individual y only varies the degree of motion of his arms 2% or not at all. Accordingly, individual x's reference biometric profile may allow deviations of 20% in arm motion, whereas individual y's reference biometric profile may only allow deviations of 2%. Allowed deviations may also be situation based. According to some embodiments, multi-factor biometric identification/authentication may be performed by an IBBE system, i.e. a set of different types of biometric parameters of a subject may be compared to a set of different types of reference biometric parameters in a stored reference biometric profile. In such cases, different types of biometric parameters may receive different weights in evaluating a match between the subject parameters and a reference profile. Further, the weights assigned to different biometric parameter types may be situation/circumstance dependent. For example, in low lighting conditions the value of color based parameters may be reduced (as color may deviate in poor lighting) or in extremely cold conditions the value of a walking speed parameter may be reduced (as people tend to change their walking speed in extreme cold).

According to some embodiments, correlation of subject indicators/biometric-parameters to reference indicators/biometric-parameters may be performed in a multistage process, wherein one or more indicators/parameters may be used to first eliminate and/or identify a group of possible matches, such that correlation based on other parameters is performed in relation to a smaller group of reference indicators/biometric-parameters. For example, a first stage of correlation may comprise correlation of static biometric parameters, and a second stage correlation of dynamic parameters between the subject indicators/parameters and the group of reference indicators/parameters correlated to the subject indicators/parameters based on the static parameters.

According to further embodiments, Subject Identification/Recognition/Categorization/-Tracking/Monitoring/Authentication Sub-Systems may interact with other Subject/Identification/-Recognition/Categorization/Tracking/Monitoring/Authentication Systems to facilitate multi-modal identification/recognition/categorization/tracking/monitoring/authentication, which other systems may be third party systems. For example, a biometric subsystem configured to track subjects based on motion parameters may interact with a facial recognition system to facilitate multi-modal tracking of subjects.

According to some embodiments, visually detected features may be static and/or dynamic features. Any combination of static and/or dynamic features may be acquired and analyzed to estimate a subject indicator or subject biometric parameter. The acquired static/dynamic features or combination thereof may include the subject's: height, width, volume, limb sizes, ratio of limb sizes, ratio of limb to torso sizes, limb/head shape, heights of different body parts during motion (e.g. max/min head heights when walking) or change of heights during motion, angular or distantial range of motion between different limbs and limb parts, angular or distantial range of motion between limb parts and torso or other body parts, head size, head movements, movement parameters of body parts when performing certain movements (e.g. parameters of hand motions when waving hello), hair color and configuration, facial features, shape and dimensions of specific body parts (e.g. ear shape and/or dimensions), distinguishing marks, clothing type and arrangement, unique wearable accessories and so on. Any other visually detectable features or combinations of features known today or to be discovered or devised in the future are applicable to the present invention.

Further embodiments of the present invention may include methods, circuits, apparatuses, systems and associated computer executable code for providing video based surveillance, identification, recognition, monitoring, tracking and/or categorization of individuals based on visually detectable dynamic features of the subject, such as the subject's motion dynamics. According to some embodiments, spatiotemporal characteristics of an instance of a given individual moving in a video sequence may be converted into: (1) one or more Body Part Specific Motion Profiles (BPSMP), and/or (2) a set of Body Part Specific Frequency Coefficients (BPSFC) or Body Part Specific Motion Amplitudes (BPSMA). Either the BPSMP, BPSFC, BPSMA may be stored as subject indicators and used as reference(s) for identifying another instance of the given subject/individual in another image/video sequence. According to further embodiments, one or more limbs, a torso and optionally the head/neck (referred to as Body Parts) of an individual in a video sequence may be individually tracked while the individual is in motion. Tracking of body part movements may be analyzed and used to generate a motion profile for one or more of the tracked body parts. The body part specific motion profiles may indicate recurring patterns of body part motion while the subject is walking, running or otherwise moving. Additionally, one or more of the motion profiles may be used to generate one or a set of motion related frequency coefficients and/or amplitudes for each of the tracked body parts. Motion related frequency coefficients associated with a given body part may be referred to as a Body Part Specific Frequency Coefficient, and one or more BPSFC's may be generated for each tracked body part. The one or more BPSFC's for each given tracked limb/torso/head may be indicative of spatiotemporal patterns (e.g. cyclic/repeating movements) present in the given tracked part while the individual subject is in motion, for example during walking or running.

One or an aggregation of body part specific motion profiles BPSMP of an individual (e.g.: (1) right arm, right leg and head; (2) right arm, left arm, left leg and right shoulder) may be stored, indexed, and later referenced as part of a Motion Signature Vector (MSV). Combinations or an aggregation of BPSFC's relating to different body parts of the same given individual (e.g.: (1) right arm, right leg and head; (2) right arm, left arm, left leg and right shoulder) may also be stored, indexed, and later referenced as part of the same or another Motion Signature Vector (MSV) for the same given individual. Accordingly, matches or substantial matches between corresponding BPSMP's and/or BPSFC's and/or BPSMA's of a stored reference MSV and corresponding profiles and/or BPSFC's derived from an individual being video tracked may indicate that the person being video tracked is the same person who was the source of the reference MSV.

Reference BPSMP value ranges and reference BPSFC/BPSMA value ranges, or any combination thereof, may be indicative of a specific subject categorization, including: age ranges, genders, races, etc. Accordingly, an MSV derived from a video sequence of a given subject and including BPSMP values and/or BPSFC/BPSMA values within specific reference ranges defined to be associated with a specific category (e.g. age range, gender, race, etc.) may indicate that the given subject in the video sequence belongs to the specific category (e.g. age range, gender, race, etc.).

According to some embodiments, one or more BPSMP of a walking pattern of a subject may be extrapolated from a video sequence. It should be noted that a body/head of a human walking typically moves in a spiral pattern, going up and down and left to right simultaneously in a cyclic motion as the person walks. This motion can be tracked, by tracking one or more points on the subject's body/head, as the subject walks. Accordingly, one or more BPSMP's of a walking pattern of a subject may include one or more of:

a. a max/min height of the subject when walking;

b. an amplitude and/or frequency of the spiral pattern;

c. a shape of the spiral pattern;

d. an amplitude and/or frequency of the sideways motion of the subject when walking;

e. a speed of progression; and

f. relations between one or more of the above parameters;

g. any other parameter of the spiral pattern.

Furthermore, characteristics of a subjects spiral pattern when walking may indicate a mood/intention/state of the subject. For example, a man angry and determined may exhibit specific types of patterns discernable from regular walking patterns which may be used to identify subjects about to commit a crime of violence.

It can further be noted that hands/arms of a human walking typically move when the human is walking, going forward and back along the subject's side as the subject walks. Accordingly, one or more BPSMP's of a walking pattern of a subject may include one or more of:

a. a max/min height of the arm/hand when walking, i.e. amplitude of the motion;

b. a frequency/speed of the arm/hand motion;

c. angles between the arm/hand and other body parts in different stages of the motion;

d. positions of the palms and their relations to the arm in different stages of the motion;

e. a relationship between the arm/hand motion and the other bodily motions;

f. relations between one or more of the above parameters;

g. positions and angles of joints in different stages of the motion; and/or

h. any other parameter of the arm/hand motion.

According to further embodiments, movements of other limbs and body parts during motion may be similarly analyzed such that BPSMP's of a walking pattern of a subject may include parameters of these motions as well.

According to some embodiments, BPSMP's of a walking pattern of a subject appearing in a video may be used to identify a subject by comparing the BPSMP's to reference BPSMP's of walking pattern of subjects stored in a reference database, either alone or in concert with other parameters associated with the subject. According to further embodiments, BPSMP's of a walking pattern of a subject may be used to track the subject when moving through an area including multiple video acquisition subsystems, e.g. in an airport.

According to some embodiments, one or more BPSMP's of one or more gestures of a subject may be extrapolated from a video sequence and used to identify and/or authenticate a subject. For example, one or more BPSMP's of a hand waving motion of a subject may be used to identify/authenticate the subject, alone or in concert with other identification/authentication parameters. It should be understood that the following description is presented in relation to a hand waving motion by way of example and that any other gesture may be equally used with the appropriate modifications. One or more BPSMP's of a hand waving of a subject may include one or more of:
a. an amplitude and/or frequency of the waving motion, i.e. distance of movement and speed of movement;
b. a shape/pattern of the hand motion, e.g. arced, elipsoid;
c. locations of the arm and palm in relation to the body during the motion, e.g. height in relation to shoulder, angle of the elbow during stages of the motion;
d. finger and palm positions during the motion;
e. relations between hand and arm movements;
f. relations between one or more of the above parameters;
g. positions and angles of joints during the gesture; and
h. any other parameter of the gesture.

According to some embodiments, there may be provided a biometric based authentication system which may include IBBE functionalities and may authenticate a subject by comparing one more BPSMP's of the subject to a record or table of records of reference BPSMP's of registered/permitted users/subjects. Such a system may include an image sensor (e.g. webcam) or may be functionally associated with such a sensor. The biometric based authentication system, may receive one or more images of a subject attempting authentication, from the image sensor. The biometric based authentication system may extrapolate BPSMP's of the subject from the received images and compare them to reference BPSMP's of registered/permitted users/subjects to verify the subject is permitted access to the requested resource, i.e. authenticate the user. For the purpose of authentication the subject may be required to perform one or more gestures or motions from which the system may extrapolate the relevant BPSMP's. For example, the subject may be required to wave to the camera when attempting authentication. According to further embodiments, a biometric based authentication system may interact with another type of authentication system or process to supplement the other authentication process. For example, a subject waving to the camera may also be required to enter a password to provide for multi-factor authentication.

According to some embodiments, the systems and methods described herein may be used to determine motion parameters of tracked subjects in an area and compared to a reference of natural ranges of motion parameters of humans. Thereby, subjects exhibiting unnatural motion parameters may be identified. Often times persons with unlawful or malicious/suspicious intentions will exhibit unnatural motion parameters. In this fashion, such individuals can be identified in a group of people and the appropriate authorities alerted. This feature can be especially useful in monitoring of areas containing large groups of people, e.g. airports, large events, public speeches, etc.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is an illustration of an exemplary IBBE based system Image/Video Sensor monitoring an area, with exemplary skeletal models fitted to monitored subjects, all in accordance with some embodiments of the present invention;

FIG. 2 is an illustration of exemplary IBBE based system Image/Video Sensors monitoring multiple areas of an airport, in accordance with some embodiments of the present invention;

FIG. 3 is an illustration of an exemplary IBBE based Authentication system authenticating a User based on an authentication gesture, all in accordance with some embodiments of the present invention;

FIG. 4 is an illustration of an exemplary Skeletal Model fitted to a monitored subject and exemplary biometric parameters extrapolated from the fitted skeletal model, all in accordance with some embodiments of the present invention;

FIG. 5 is an illustration of a man walking, illustrating exemplary Dynamic Biometric Parameters of a walking pattern of a monitored subject, in accordance with some embodiments of the present invention;

FIG. 6 is an illustration of a man performing an exemplary authentication gesture of hand waving, illustrating exemplary Dynamic Biometric Parameters of a monitored subject waving his/her hand, in accordance with some embodiments of the present invention;

FIG. 7 is an illustration of a man speaking to an audience while the area is being monitored by an exemplary IBBE system, wherein examples of subjects matching crowd specific suspicious Biometric profiles are illustrated, all in accordance with some embodiments of the present invention;

FIG. 8 is an illustration of a Casino while the area is being monitored by an exemplary IBBE casino monitoring system, wherein examples of subjects matching Casino specific suspicious Biometric profiles are illustrated, all in accordance with some embodiments of the present invention;

FIGS. 9A-11A are functional block diagrams of exemplary IBBE based systems, in accordance with some embodiments of the present invention, wherein:

FIG. 9A illustrates an exemplary IBBE based human detection, identification, recognition and tracking/monitoring system, in accordance with some embodiments of the present invention;

FIG. 9B illustrates an exemplary IBBE based human detection, identification, recognition and tracking/monitoring system, wherein models are used to extrapolate Biometric Parameters, all in accordance with some embodiments of the present invention; and

FIG. 10A illustrates an exemplary IBBE based human authentication system, in accordance with some embodiments of the present invention;

FIG. 10B illustrates an exemplary IBBE based human authentication system, wherein models are used to extrapolate Biometric Parameters, all in accordance with some embodiments of the present invention;

FIG. 11A illustrates an exemplary IBBE based human position monitoring system, in accordance with some embodiments of the present invention; and

FIG. 11B illustrates an exemplary IBBE based human position monitoring system, wherein Biometric Parameter Analysis is used to identify suspicious positions, all in accordance with some embodiments of the present invention;

FIGS. 12A-15D are flowcharts including steps of exemplary methods of use of IBBE based systems, in accordance with some embodiments of the present invention, wherein:

FIG. 12A is a flowchart including steps of operation of an exemplary IBBE based human identification/recognition/tracking/monitoring system, in accordance with some embodiments of the present invention;

FIG. 12B is a flowchart including steps of operation of an exemplary IBBE based human identification/recognition/tracking/monitoring system, wherein profile matching is performed in 2 steps (first identifying group of profiles matching static parameters and then identifying, within the group, profiles matching dynamic biometric parameters), all in accordance with some embodiments of the present invention;

FIG. 12C is a flowchart including steps of operation of an exemplary IBBE based human identification/recognition/tracking/monitoring system, wherein models are used to extrapolate biometric parameters and profile matching is performed in 2 steps (first identifying group of profiles matching static parameters and then identifying, within the group, profiles matching dynamic biometric parameters), all in accordance with some embodiments of the present invention;

FIG. 13A is a flowchart including steps of operation of an exemplary IBBE based suspicious human detection system, in accordance with some embodiments of the present invention;

FIG. 13B is a flowchart including steps of operation of an exemplary IBBE based suspicious human detection system, wherein models are used to extrapolate biometric parameters, all in accordance with some embodiments of the present invention;

FIG. 14A is a flowchart including steps of operation of an exemplary IBBE based Authentication system, in accordance with some embodiments of the present invention;

FIG. 14B is a flowchart including steps of operation of an exemplary IBBE based Authentication system, wherein models are used to extrapolate biometric parameters, all in accordance with some embodiments of the present invention;

FIGS. 14C-14D are flowcharts including steps of operation of exemplary IBBE based Authentication systems including multi-modal authentication, all in accordance with some embodiments of the present invention;

FIGS. 14E-14F are flowcharts including steps of operation of exemplary IBBE based Authentication systems including multi-modal authentication, wherein models are used to extrapolate biometric parameters, all in accordance with some embodiments of the present invention;

FIGS. 15A-15D are flowcharts including steps of operation of exemplary IBBE based Human Detection systems, in accordance with some embodiments of the present invention;

FIG. 16A is a functional block diagram of an exemplary video based subject presence response system, including a video acquisition sub-subsystem, video analytics sub-system, a subject or category identification sub-system, and a subject response sub-system, all in accordance with some embodiments of the present invention;

FIG. 16B is a flowchart including exemplary steps of a generic method of operation of a Subject Presence Response System (SPRS), in accordance with some embodiments of the present invention;

FIG. 16C is a flowchart including exemplary steps of a subject registration method of a Subject Presence Response System, in accordance with some embodiments of the present invention;

FIG. 17 is a flowchart including exemplary steps of a security related operation of a Subject Presence Response System (SPRS), in accordance with some embodiments of the present invention;

FIG. 18 is a flowchart including exemplary steps of an environmental related operation of a Subject Presence Response System (SPRS), all in accordance with some embodiments of the present invention;

FIG. 19 is a flowchart including exemplary steps of a content presentation related operation of a Subject Presence Response System (SPRS), in accordance with some embodiments of the present invention;

FIG. 20 is a flowchart including exemplary steps of a process by which: (1) static and dynamic features (biometric parameters) may be extracted from a video sequence, (2) subject indicators may be generated and used as or with reference indicators, all in accordance with some embodiments of the present invention;

FIGS. 21A-21C show an exemplary series of images illustrating extraction of both static and dynamic subject features (biometric parameters) from a conventional surveillance video sequence, all in accordance with some embodiments of the present invention;

FIG. 22 shows a series of images illustrating an exemplary conversion of a conventional video sequence into Body Part Specific Motion Profiles, in accordance with some embodiments of the present invention; and

FIG. 23 shows a flow chart including exemplary steps of a process by which body part specific motion profiles may be converted into one or more sets of body part specific frequency coefficients and then aggregated into a Motion Signature Vector MSV for the subject comprised of BPSFC's grouped by body part, all in accordance with some embodiments of the present invention;

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description herein. In addition, embodiments of the present invention are not described with reference to any particular programming language. It will be appreciated that a variety of programming languages may be used to implement the teachings of the inventions as described herein.

The present invention includes methods, systems, apparatuses, circuits and associated computer executable code for providing video based subject characterization, categorization, identification, recognition, tracking, monitoring, authentication and/or presence response. According to some embodiments, there may be provided one or more Image Based Biometric Extrapolation (IBBE) methods, systems and apparatuses adapted to extrapolate static and/or dynamic biometric parameters of one or more subjects, from one or more images or video segments including the subjects. According to some embodiments, extrapolated biometric parameters of subjects may be used to detect, identify, recognize, track/monitor and/or authenticate the subjects. According to further embodiments, extrapolated biometric parameters may be used to determine physical positions of subjects and may further be used to identify one or more subjects exhibiting suspicious behavior (or otherwise interesting biometric parameters) based on their physical positions and/or other biometric parameters.

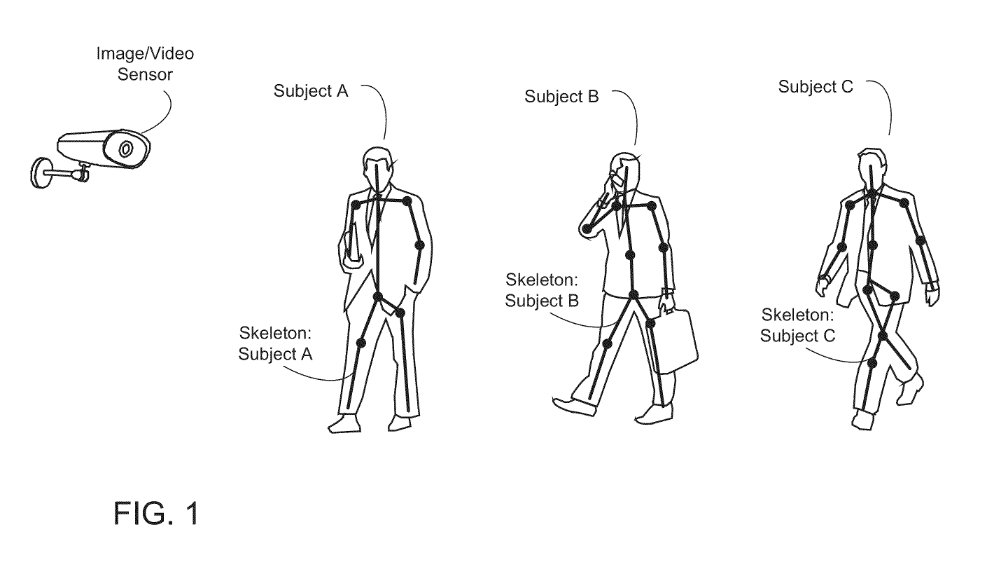

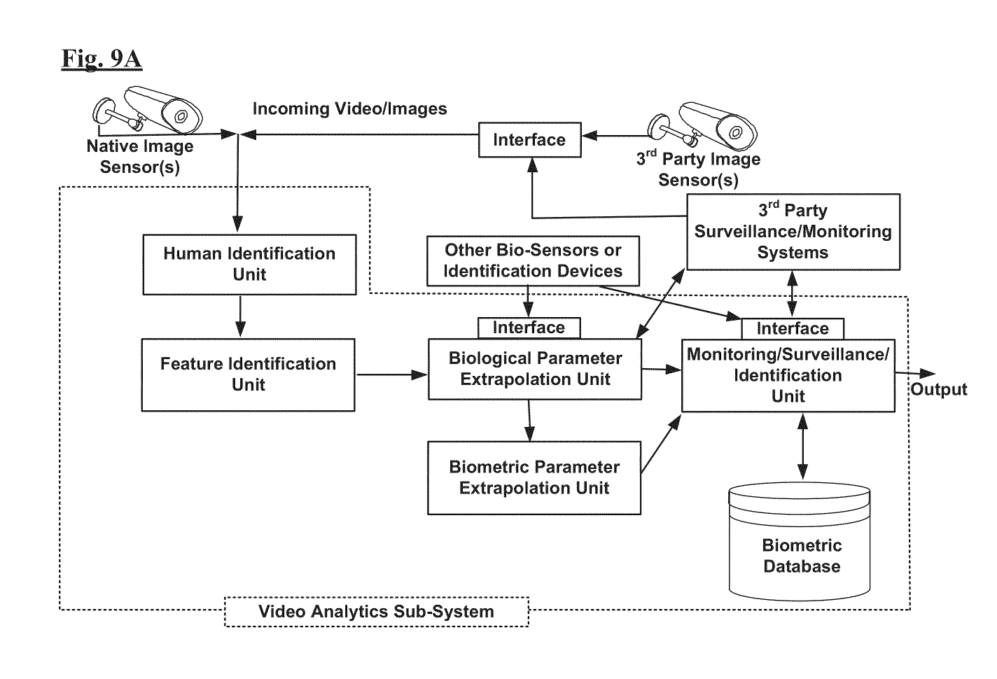

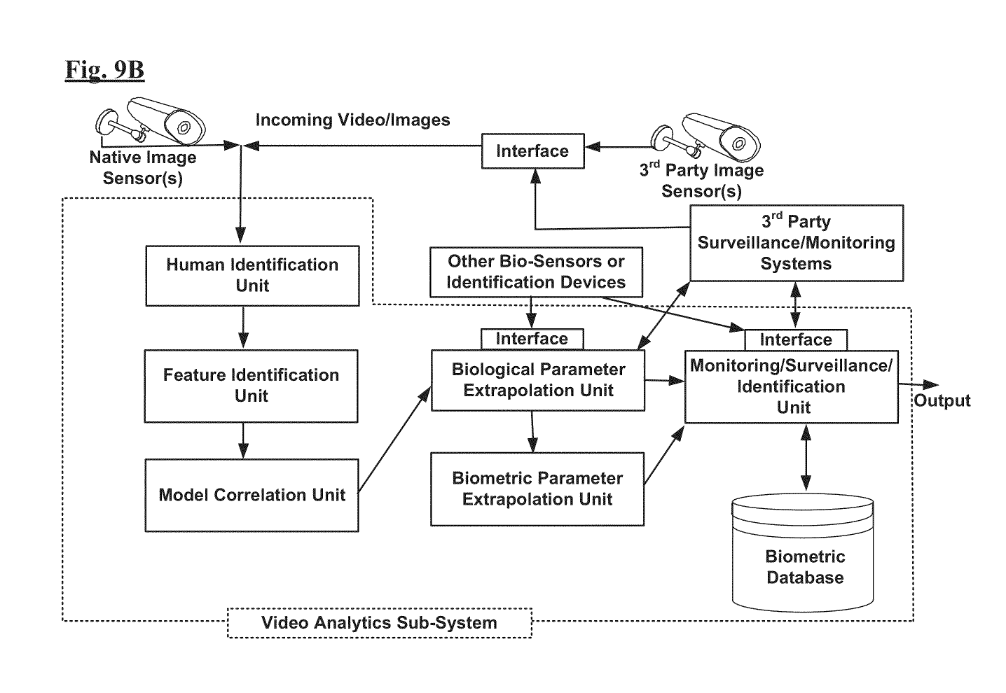

According to some embodiments, biometric parameters may be extrapolated from images and/or video segments. The images and/or video segments may be acquired by one or more native image sensors of the system and/or may be received from third parties. Accordingly, according to some embodiments, there may provided one or more video/image acquisition sub-systems which may include cameras, video circuits and ports, and which may be adapted to capture one or more images/videos of subjects (e.g. person, adult, child, etc.) [see FIGS. 1-3, 7-8 and 9-11]. Furthermore, according to further embodiments, there may be provided one or more interfaces adapted to receive images and/or video data from third party image/video sensors and/or image/video processing systems [see FIGS. 9-11]. Third party data may be analyzed in conjunction or separately from image/video data received from native video/image acquisition sub-systems. The one or more video acquisition sub-systems may be integral or otherwise functionally associated with a video analytics sub-system [see FIGS. 9-11], which video analytics sub-system may include various image processing modules, logic and circuits, and which may be adapted to extract, extrapolate or estimate from the images/videos biological parameters of subjects appearing in the images/video, static and/or dynamic, such as: height, width, volume, limb sizes, ratio of limb sizes, ratio of limb to torso sizes, limb/head shape, heights of different body parts during motion (e.g. max/min head heights when walking) or change of heights during motion, angular or distantial range of motion between different limbs and limb parts, angular or distantial range of motion between limb parts and torso or other body parts, head size, head movements, movement parameters of body parts when performing certain movements (e.g. parameters of hand motions when waving hello), hair color and configuration, facial features, shape and dimensions of specific body parts (e.g. ear shape and/or dimensions), distinguishing marks, clothing type and arrangement, unique wearable accessories, and so on. The extracted subject features may be analyzed and characterized/quantified to generate one or more subject indicators or subject biometric parameters which may include biometric parameters or indicators indicative of the subject's: (1) age, (2) gender, (3) ethnicity, (4) demographic, (5) physical attributes, (6) motion attributes, (7) physical condition, (8) mental state, (9) behavioral characteristics; (10) current intention(s) and/or (11) any other biometric parameters. Some indicators or sets of indicators derived from dynamic (motion) features of the subject may include body part motion profiles, combinations of body part motion profiles and derivative thereof including motion frequency coefficients and amplitudes.

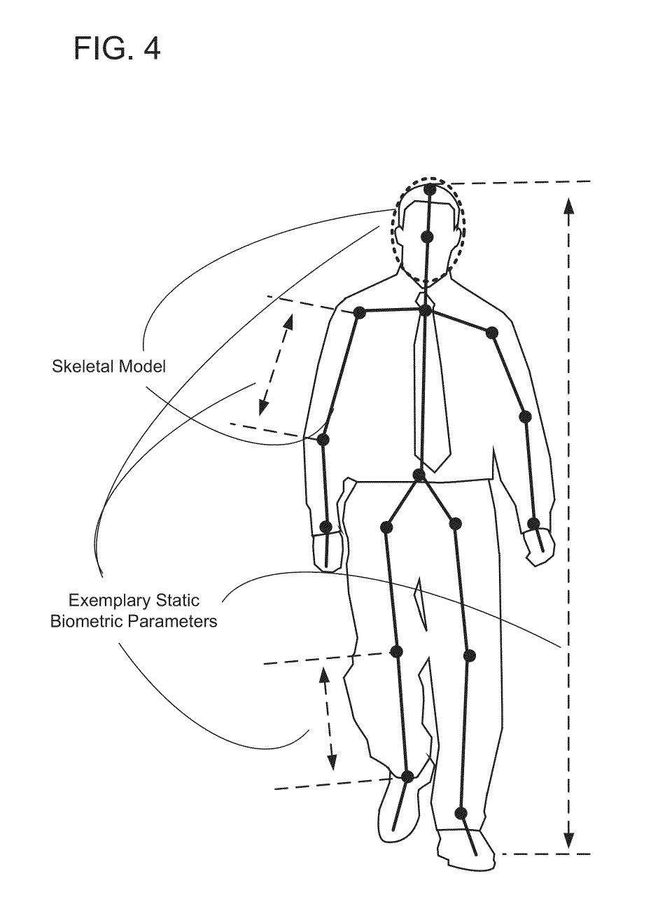

According to some embodiments, biological parameters of subjects may be extrapolated from images by first correlating one or more skeletal models (2D or 3D) to the subjects [see FIGS. 1 and 4-6]. Based on a correlation of a skeletal model, dimensions and relations of body elements may be extrapolated [see FIG. 4]. A description of methods and systems for correlating skeletal models to subjects appearing in images is provided in U.S. Pat. No. 8,114,172, titled “SYSTEM AND METHOD FOR 3D SPACE-DIMENSION BASED IMAGE PROCESSING”, which is hereby incorporated into the present application in its entirety. Further, a correlation of a skeletal model to a subject in one or more images of a sequence may then be used to correlate the model to previous/future images in the sequence, i.e. once a skeletal model is correlated to a subject, previous images in the sequence may be analyzed based on the later correlated model. In other words, once a skeletal model has been correlated to a subject, many static biometric parameters may be extrapolated from the skeletal model, such as: (1) limb dimensions (e.g. arm length) and limb part dimensions (e.g. forearm length, finger length), (2) body dimensions (e.g. height, max. width) and body part dimensions (e.g. torso height and width, hip measurement, head circumference), (3) body and body part shapes and angles (e.g. head frontal cross section shape, finger joint angles, pelvic shape), (4) body part relations (e.g. ratio of torso to head size, ratio of hand to finger sizes), (5) body volume or body part volume, and (6) any other static biometric parameter [see FIG. 4]. According to further embodiments, other image analysis techniques (e.g. color analysis, contour identification, etc.) may be used to determine one or more static biometric parameters of a subject, either alone or in conjunction with skeletal modeling techniques. Further, based on a correlated skeletal model of a subject, body elements of a subject may be tracked to extrapolate motion parameters of the body elements and relations between them. Again, According to further embodiments, other image analysis techniques (e.g. color analysis, contour identification, etc.) may be used to extrapolate motion parameters of body elements of a subject and relations between them, either alone or in conjunction with skeletal modeling techniques. In other words, one or more points on or sections of a body of a subject may be tracked over a series of images, either by means of skeletal models or by other tracking techniques, to extrapolate dynamic biometric parameters of the subject, such as speed, frequency and range of movements of different body parts during different activities (e.g. parameters of arm movements during walking) and relations between parameters of these movements (e.g. relations between arm and leg movements during walking) According to further embodiments, skeletal model correlation and tracking may be joint based. In other words, a skeletal model may be correlated to an individual by correlating the locations and angles of the joints of the model to the joints of the individual. Accordingly, tracking of body parts of an individual and their motion may be performed by tracking the locations, positions and angles of the joints during the motion. Further, in relation to the description below, it should be understood that all descriptions relating to parameters of body parts and their motions may equally relate to parameters of joints and their motion, such that a portion or all of the analysis described herein may be performed entirely or partially based on joint identification, modeling and tracking alone.

Referring to FIG. 1, a video/image sensor monitoring an area can be seen. As shown, an IBBE system may correlate skeletal models to subjects detected in the monitored area to extrapolate biometric parameters of the subjects. The correlated skeletal models may then be used to extrapolate static biometric parameters of the subjects (e.g. height, arm length, etc.). further, these models may be used to track one or more body parts or points on body parts during the subject's movement to extrapolate dynamic biometric parameters of the subjects.

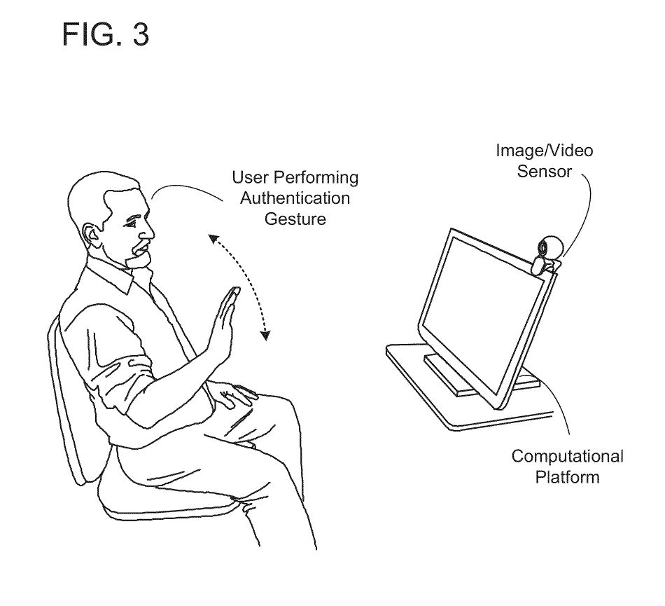

According to some embodiments, biometric parameters of subjects may be extrapolated by passively monitoring subjects (e.g. from surveillance images and video) [see FIGS. 1-2 and 7-8] and/or by actively monitoring subjects (e.g. a subject may be requested to perform a wave of his/her hand to determine dynamic biometric parameters of the subjects hand waving) [see FIG. 3].

A Subject Identification/Recognition/Categorization/Tracking/Monitoring/Authentication Sub-System may be comprised of modules, logic and circuits adapted to receive the extracted subject biometric parameters, access a biometric parameter reference database of stored subject biometric parameters, and to either identify and/or categorize/characterize the subject. The identification/categorization sub-system may attempt to correlate the received subject biometric parameters with reference subject/category biometric parameters and/or biometric parameter profiles in the biometric parameter reference database and/or may store received subject biometric parameters/profiles for future reference. The reference subject biometric parameters stored in the reference database may either be associated with specific subjects (e.g. individual by the name of Dor Givon) or with one or more groups, types or categories of subjects (e.g. Male, Asian, Adult, Men who previously passed by entrance X, suspicious humans, etc.).

Correlation between a set of received subject biometric parameters and reference biometric parameters stored on the reference database may be absolute or partial. In certain situations, the set of subject biometric parameters received for a subject (individual) being tracked may be smaller than the set of reference biometric parameters stored for that subject in the reference database. In such an event, a partial match between the received biometric parameters and the reference biometric parameters may suffice for an identification, recognition, authentication, monitoring or categorization (optionally: only as long as the match between corresponding biometric parameters is sufficiently high). Different degrees of match between the determined biometric parameters of a subject and reference parameters may be required for different uses of the system; e.g. a higher matching degree may be required for authentication purposes than for tracking purposes. In other cases, the set of subject biometric parameters received for a subject (individual) being tracked may be larger than the set of reference indicators stored for that subject in the reference database. In such an event, once a match between the received indicators and the reference indicators is made (optionally: only when match between corresponding indicators being sufficiently high) and the individual subject is identified, that subject's records in the reference indicator database may be updated to include the new and/or updated subject indicators received from the analytics sub-system. According to further embodiments, certain types of indicators may receive different weights in correlation, such that, for example, a correlated physical height indicator may be factored more heavily than a clothing related indicator. Furthermore, one or more indicator types correlations may allow for deviations in parameters which will still be considered matching in degrees which may vary from indicator type to indicator type (for example, deviations in walking speed of less than 10% may still be considered matches while deviations of 10% in height will not). Yet further, allowed deviations in parameters may vary from individual to individual, possibly based on a degree of deviation determined when obtaining a reference profile for the individual. For example, it may be determined that individual x varies the degree of motion of his arms as much as 20% during walking whereas individual y only varies the degree of motion of his arms 2% or not at all. Accordingly, individual x's reference biometric profile may allow deviations of 20% in arm motion, whereas individual y's reference biometric profile may only allow deviations of 2% in arm motion. Accordingly, extrapolating reference profiles of individuals may include both recording parameter values/ranges for different biometric parameters and extrapolating degrees of deviation in each biometric parameter for the individual. Allowed deviations may also be situation based.

According to some embodiments, multi-factor biometric identification/authentication may be performed by an IBBE system, i.e. a set of different types of biometric parameters of a subject may be compared to a set of different types of reference biometric parameters in a stored reference biometric profile. For example, a set of subject dynamic walking related biometric parameters may be compared to walking related parameters of a reference profile alongside comparison of the subject's static biometric parameters (e.g. height and head shape). In such cases, the amount of matching parameters required for identification/authentication and the degree of matching required may depend on the purpose of identification/authentication. For example, at the entrance to a nuclear facility a large number of matching parameters along with a high degree of match in each parameter may be required, whereas for purposes of tracking individuals moving through an amusement park to determine their park facility usage habits, a much smaller amount and degree of matching parameters may suffice. According to some embodiments, multi-biometric-factor type identification/authentication may include calculation of a match score between a set of extrapolated subject biometric parameters (static and dynamic) and a reference profile of biometric parameters. The match score may be calculated by first determining a degree of correlation between each specific extrapolated biometric parameter and the corresponding reference biometric parameter in the reference profile to determine a match score for the specific type of biometric parameter. As stated, the match score for each specific type of biometric parameter equated with each degree of correlation may differ between parameter types (e.g. a 2% deviation in walking speed between a subject's walking speed and a reference profile walking speed may result in a higher match score for walking speed than a 2% deviation in height). Further, the match score for a given type of biometric parameter equated with each degree of correlation may differ in different conditions/environments, e.g. a given degree of correlation in walking speed may result in a higher match score in cold weather (where people are expected to change their walking speed) than in normal weather or a different degree of correlation may be expected in low quality images, etc. Further examples of distinguishing conditions may include: lighting, the quality of the reference profile, the purpose of the identification/authentication, the angle of image capture, the nature of the activity in which the subject is involved as opposed to the nature of the activity the subject was involved in during capture of the reference profile parameters (e.g. a subject walking while speaking to a friend as opposed to a subject walking alone or a subject at a business function as opposed to a subject at a social event, etc.). According to further embodiments, the matching algorithm may include predefined adaptations/mappings/normalizations of parameters for given conditions, e.g. walking speed at extremely cold temperatures may automatically be reduced by 10% or walking/standing parameters may include automatic adaptations/mappings/normalizations between business and social conditions. Such automatic adaptations/mappings/normalizations may be based on a statistical analysis of multiple subject biometric parameters in different conditions, i.e. an IBBE system may include self-learning algorithms. Further, experimentation with known subjects in different conditions may be performed to collect statistical data for this purpose. Once a match score for each type of extrapolated biometric parameter has been determined a total biometric profile match score may be determined by aggregating the match scores for each type of biometric parameter. When aggregating the match scores, different types of biometric parameters may receive different weights in evaluating a match between the subject parameters and a reference profile. For example, correlation in height may be more influential than correlation in walking speed. Further, the weights assigned to different biometric parameter types may be situation/circumstance dependent. For example, in low lighting conditions the value of color based parameters may be reduced (as color may deviate in poor lighting) or in extremely cold conditions the value of a walking speed parameter may be reduced (as people tend to change their walking speed in extreme cold). Further examples of distinguishing conditions may include: lighting, the quality of the reference profile or the quality of each of the types of biometric parameters in the reference profile and/or the specific extrapolated profile (for this purpose, an accuracy score may be given to reference and/or extrapolated biometric parameters during their determination by the system), the purpose of the identification/authentication, the angle of image capture, the nature of the activity in which the subject is involved as opposed to the nature of the activity the subject was involved in during capture of the reference profile parameters (e.g. a subject walking while speaking to a friend as opposed to a subject walking alone or a subject at a business function as opposed to a subject at a social event, etc.).

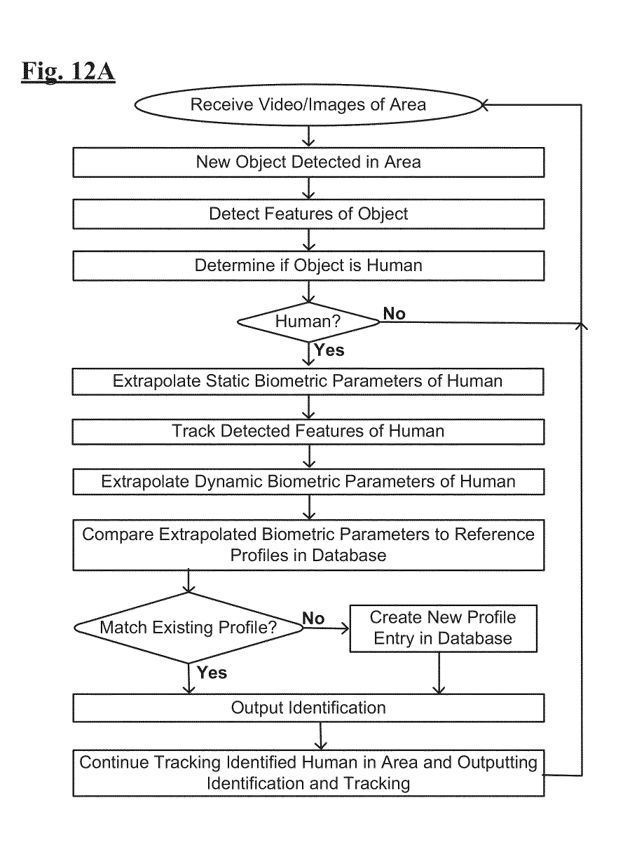

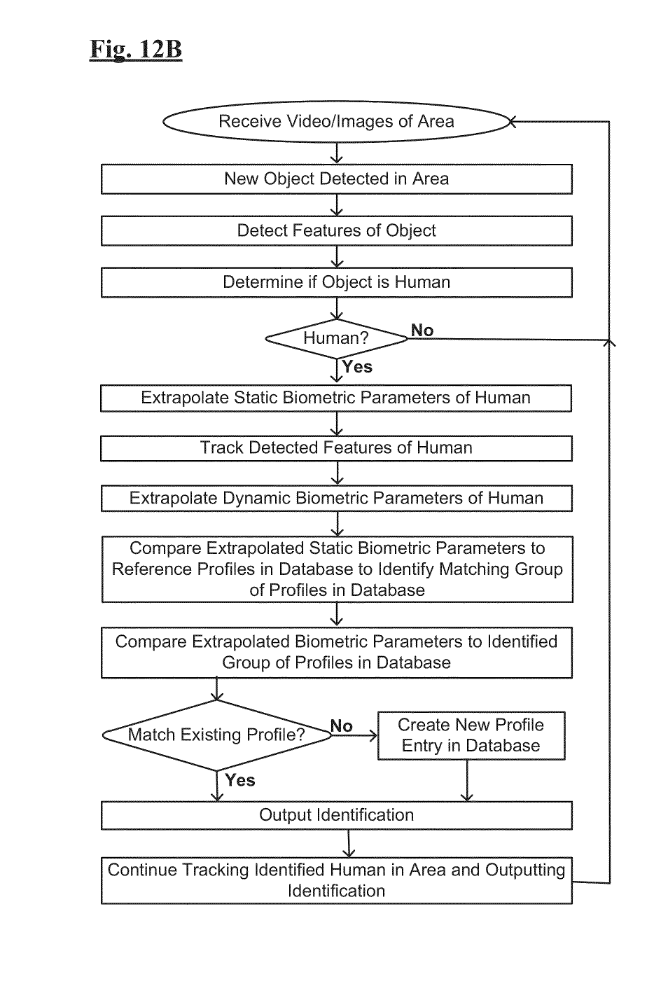

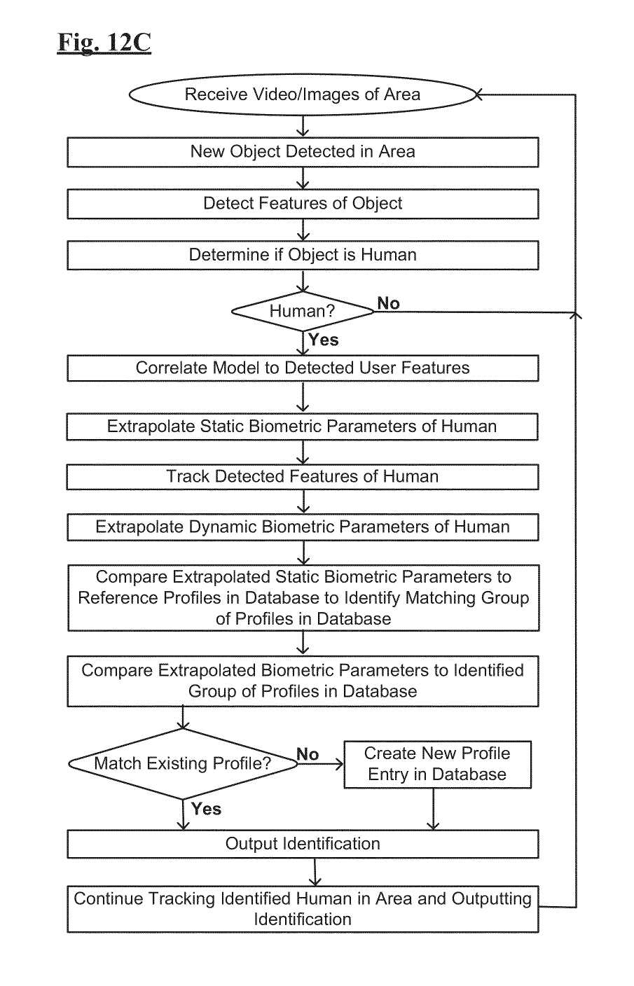

According to some embodiments, correlation of subject indicators to reference indicators may be performed in a multistage process, wherein one or more indicators/parameters may be used to first eliminate and/or identify a group of possible matches, such that correlation based on other parameters is performed in relation to a smaller group of reference indicators [see FIGS. 12B and 12C]. For example, a first stage of correlation may comprise correlation/comparison of extrapolated static biometric parameters of a detected individual to a group of individuals or profiles having matching static biometric parameters, i.e. in a first stage a detected static biometric parameter or set of static biometric parameters of a detected individual may be used to identify a group of stored biometric profiles suspected to match the detected individual. A second stage of correlation may then comprise correlation/comparison of detected dynamic parameters of the individual to the group of reference indicators/profiles correlated to the individual based on the static parameters, i.e. the process of comparison of dynamic biometric parameters may be limited to profiles suspected to match the static biometric parameters. Other multi-stage correlation schemes are also possible. For further example, an IBBE system may first compare a subject's min and max height during walking to reference profiles to eliminate all profiles significantly deviating from the subject's min/max walking height. Subsequently, the parameters of the subject's arm movements may be compared only to the reference profiles which were found matching the subject's min/max walking height. Clearly, any such staging of analysis may be implemented to optimize the comparison process and may be tailored to the specific details of the system in question.

According to further embodiments, Subject Identification/Recognition/Categorization/-Tracking/Monitoring/Authentication Sub-Systems may interact with other Subject Identification/-Recognition/Categorization/Tracking/Monitoring/Authentication Systems to facilitate multi-modal identification/recognition/categorization/tracking/monitoring/authentication, which other systems may be third party systems [see FIGS. 9A-9B, 11A-11B and 14C-14F]. For example, a biometric subsystem configured to track subjects based on motion parameters may interact with a facial recognition system to facilitate multi-modal tracking of subjects or an IBBE based authentication system may interact with a fingerprint sensor or PIN input device to facilitate multi-factor authentication. It should be understood that many such interactions and integrations of monitoring/identification/authentication systems and methods to the described IBBE based systems are possible and should be considered within the scope of the present disclosure.

According to some embodiments, visually detected features may be static and/or dynamic features. Any combination of static and/or dynamic features may be acquired and analyzed to estimate a subject indicator or subject biometric parameter/profile. The acquired static/dynamic features or combination thereof may include the subject's: height, width, volume, limb sizes, ratio of limb sizes, ratio of limb to torso sizes, limb/head shape, heights of different body parts during motion (e.g. max/min head heights when walking) or change of heights during motion, angular or distantial range of motion between different limbs and limb parts, angular or distantial range of motion between limb parts and torso or other body parts, ratios between the described parameters, head size, head movements, acceleration and velocity of movements, movement parameters of body parts when performing certain movements (e.g. parameters of hand motions when waving hello), hair color and configuration, facial features, shape and dimensions of specific body parts (e.g. ear shape and/or dimensions), distinguishing marks, clothing type and arrangement, unique wearable accessories and so on. Any other visually detectable features or combinations of features known today or to be discovered or devised in the future are applicable to the present invention.

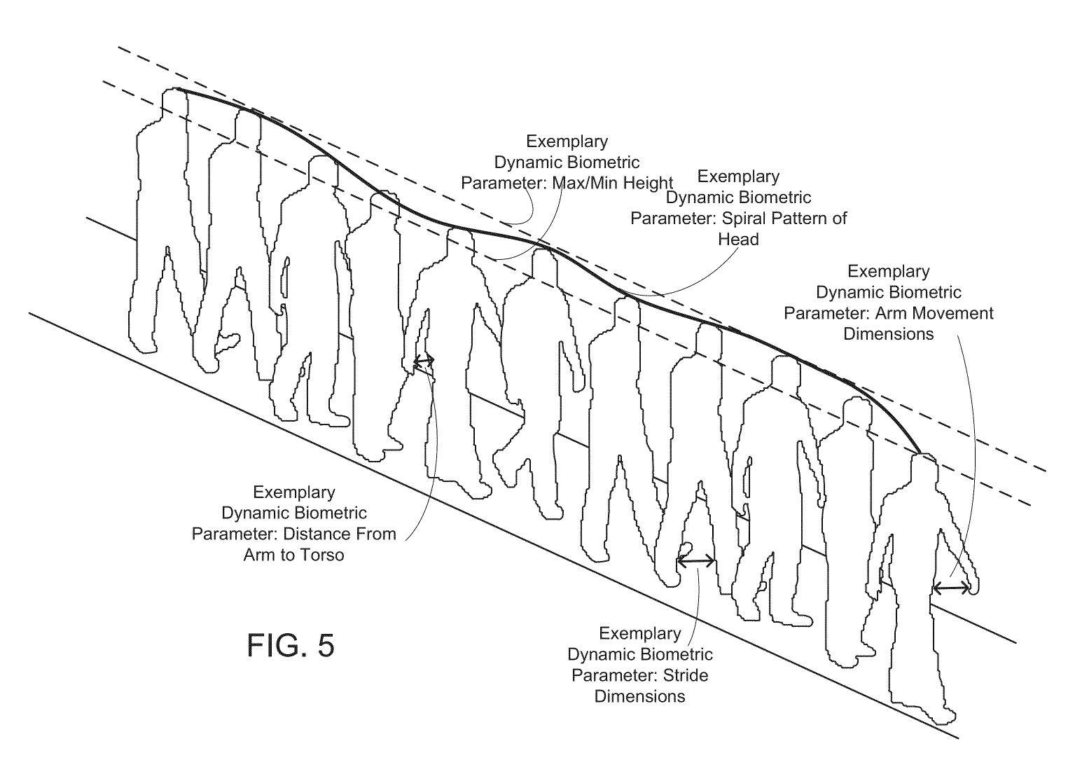

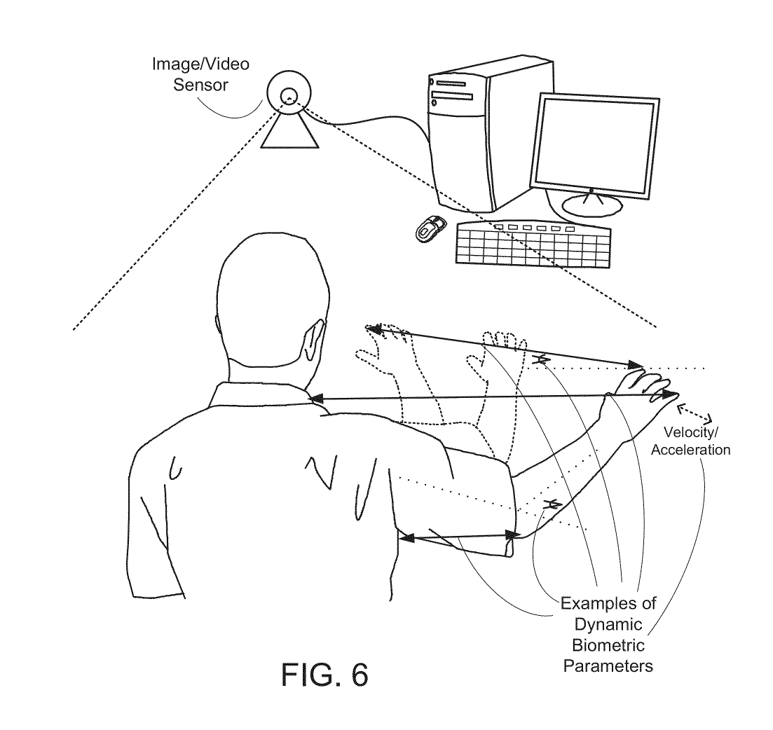

Further embodiments of the present invention may include methods, circuits, apparatuses, systems and associated computer executable code for providing video based surveillance, identification, monitoring, tracking and/or categorization of individuals based on visually detectable dynamic features of the subject, such as the subject's motion dynamics [see FIGS. 1-2, 7-8, 9A-9B and 11A-11B]. According to some embodiments, spatiotemporal characteristics of an instance of a given individual moving in a video sequence may be converted into: (1) one or more Body Part Specific Motion Profiles (BPSMP), and/or (2) a set of Body Part Specific Frequency Coefficients (BPSFC) or Body Part Specific Motion Amplitudes (BPSMA). Either the BPSMP, BPSFC, BPSMA may be stored as subject indicators and used as reference(s) for identifying another instance of the given subject/individual in another image/video sequence. According to further embodiments, one or more limbs, a torso and optionally the head/neck (referred to as Body Parts) of an individual in a video sequence may be individually tracked while the individual is in motion [see FIGS. 5 and 6]. Tracking of body part movements may be analyzed and used to generate a motion profile for one or more of the tracked body parts. The body part specific motion profiles may indicate recurring patterns of body part motion while the subject is walking, running or otherwise moving. Additionally, one or more of the motion profiles may be used to generate one or a set of motion related frequency coefficients and/or amplitudes for each of the tracked body parts. Motion related frequency coefficients associated with a given body part may be referred to as a Body Part Specific Frequency Coefficient, and one or more BPSFC's may be generated for each tracked body part. The one or more BPSFC's for each given tracked limb/torso/head may be indicative of spatiotemporal patterns (e.g. cyclic/repeating movements) present in the given tracked part while the individual subject is in motion, for example during walking, waving or running.

One or an aggregation of body part specific motion profiles BPSMP of an individual (e.g.: (1) right arm, right leg and head; (2) right arm, left arm, left leg and right shoulder) may be stored, indexed, and later referenced as part of a Motion Signature Vector (MSV). Combinations or an aggregation of BPSFC's relating to different body parts of the same given individual (e.g.: (1) right arm, right leg and head; (2) right arm, left arm, left leg and right shoulder) may also be stored, indexed, and later referenced as part of the same or another Motion Signature Vector (MSV) for the same given individual. Accordingly, matches or substantial matches between corresponding BPSMP's and/or BPSFC's and/or BPSMA's of a stored reference MSV and corresponding profiles and/or BPSFC's derived from an individual being video tracked may indicate that the person being video tracked is the same person who was the source of the reference MSV.

Reference BPSMP value ranges and reference BPSFC/BPSMA value ranges, or any combination thereof, may be indicative of a specific subject categorization, including: age ranges, genders, races, etc. Accordingly, an MSV derived from a video sequence of a given subject and/or BPSMP values and/or BPSFC/BPSMA values within specific reference ranges defined to be associated with a specific category (e.g. age range, gender, race, etc.) may indicate that the given subject in the video sequence belongs to the specific category (e.g. age range, gender, race, etc.). Similarly, reference BPSMP value ranges and reference BPSFC/BPSMA value ranges, or any combination thereof, may be indicative of a specific subject intention/behavior categorization. For example, individuals attempting or preparing to attempt a criminal/violent behavior may exhibit identifiable BPSMP value ranges and reference BPSFC/BPSMA value ranges.

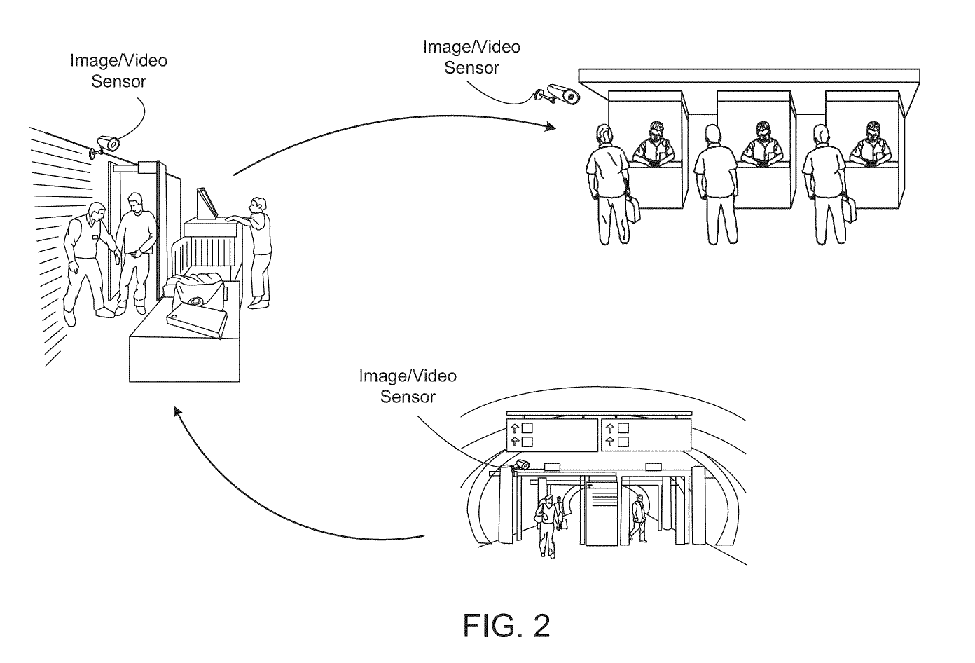

Reference is now made to FIGS. 9A-9B and 12A-12C. According to some embodiments, an IBBE system may be employed to monitor an area or facility. Such an IBBE system may include one or more image/video sensors positioned throughout the area/facility [as shown in FIG. 2]. According to further embodiments, such an IBBE system may also or alternatively receive images/video of the area from other monitoring systems or third party image/video sensors (possibly native to the facility) [as shown in FIGS. 9A-9B]. Turning to FIGS. 12A-12C exemplary steps of operation of monitoring/tracking/identifying IBBE systems are shown. The monitoring/tracking/identifying IBBE systems may detect objects in the area/facility, detect features of the objects and determine which objects are humans. Once a human is detected the IBBE system may extrapolate Static Biometric Parameters of the human, possibly by use of models, (e.g. skeletal models), as described herein. The system may further track one or more of the detected features over a series of frames to extrapolate dynamic biometric parameters of the individual. The system may then extrapolate biometric profiles of detected humans (static and/or dynamic) and compare the extrapolated profiles to reference profiles stored in an associated database. According to some embodiments, comparison to reference profiles may be performed in stages, as described herein. For example, the IBBE system may first compare a one or more static biometric profiles to reference profiles, to identify a group of reference profiles matching the one or more of the extrapolated static biometric parameters [see FIGS. 12B-12C]. the system may then compare one or more of the extrapolated dynamic biometric parameters to the identified group of profiles to find a match. The system, when a match is found, may thereby identify the human (if the reference profile is indicative of an individual), record and/or output the identification and may continue monitoring and outputting/recording the position of the individual as the individual moves through the area/facility. If a match is not found, the IBBE system may record the individual's biometric profile as a new profile and then continue monitoring and outputting/recording the individual's movements in the area/facility. Using such methods the IBBE system may be able to recognize and monitor/track the individual (based on the biometric profile) as the individual appears in images/video received from different image/video sensors. In this manner, a record/output of movement and behavior of individuals in the area/facility (such as the airport shown in FIG. 2), including identification of the individuals, may be produced—even as the individuals move out of range of one image/video sensor and into the range of another image/video sensor. For example, a video display of the monitored area may be produced, wherein each individual appearing in the display is identified in the display, and possibly further graphically marked to indicate further information regarding the individual (e.g. facility personnel may appear in a different color, or wanted subjects appearing in the display may be highlighted, etc.). Such processes may be used for many different monitoring purposes. For example, biometric profiles of wanted/suspect individuals may be stored in the associated database, such that if they appear in the monitored area they will immediately be recognized by the IBBE system and an appropriate alert issued. As biometric profiles are not necessarily dependent on physical features (e.g. a walking profile), an IBBE system may thus be able to identify the individuals even if they are disguised or wearing concealing apparel (e.g. sunglasses, hats, facial covers, etc.). Similarly, an individual who was captured by a video sensor while in disguise (e.g. a bank robber who wore a mask) may later be identified without the disguise if the video was analyzed by an IBBE system to acquire a biometric profile of the individual. Equally, movement and behavior of personnel of the facility may be monitored and recorded. Statistical data of movement of individuals in the area/facility may also be collected. For example, in an airport (as shown in FIG. 2), as each individual is monitored throughout their time in the airport, the IBBE system could determine the average time it takes a passenger to check-in, pass through security and passport control and reach their gate at any given time (this information could be used to regulate allocation of airport personnel or inform passengers of their expected total check-in time). Similarly, the average time a passenger spends at the duty free could be determined or what percentage of passengers shop at the airport, etc. In a further example, using the methods described herein an IBBE system may be able to track and monitor the movements of individuals within the monitored area/facility, identify unauthorized persons in the facility or areas of the facility having restricted access and may further be used to track the movements of authorized personnel (e.g. a facility of a corporation may be monitored to both identify unauthorized personnel in the facility and record/monitor the authorized personnel (e.g. to provide work hours, or allow/record access to restricted areas)). For further example, at the entrance to a restricted area a video/image sensor, with an associated IBBE system, may be installed to monitor the approach to the entrance. This IBBE system may identify authorized individuals approaching the entrance (based on their biometric profiles) and open the entrance for them. Further, this IBBE system may monitor the number of people passing the entrance on a given opening of the entrance to insure that an unauthorized individual doesn't take advantage of an opening of the entrance for an authorized individual in order to enter. In general, a controlled opening may be monitored to ensure that only one individual passes the opening on each given instance. It should be understood that tracking and monitoring individuals in an area/facility has endless uses, all of which should be considered within the scope of the present invention.

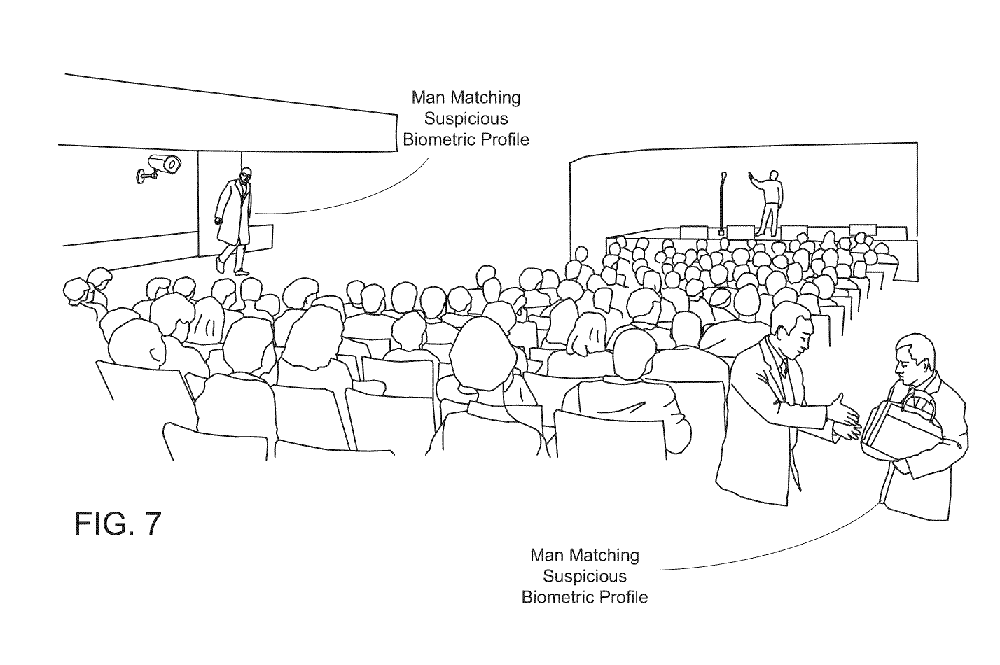

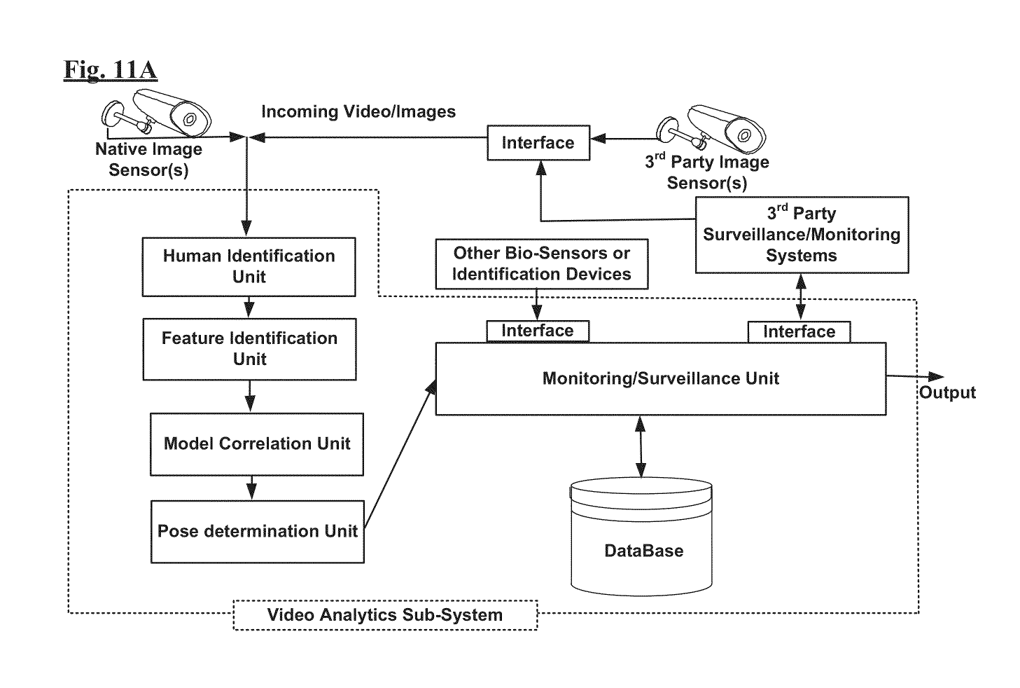

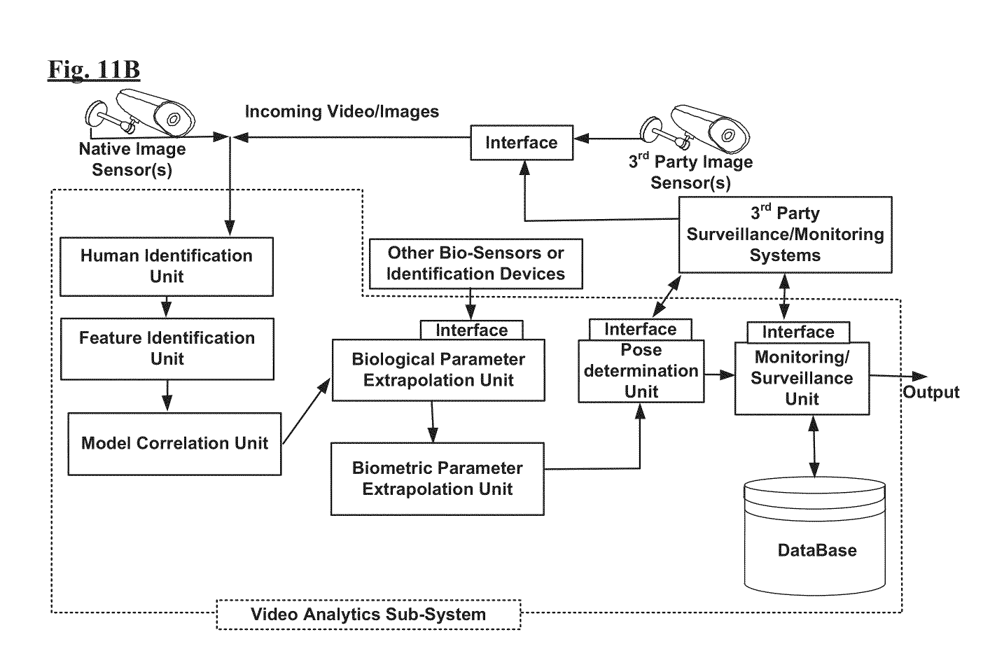

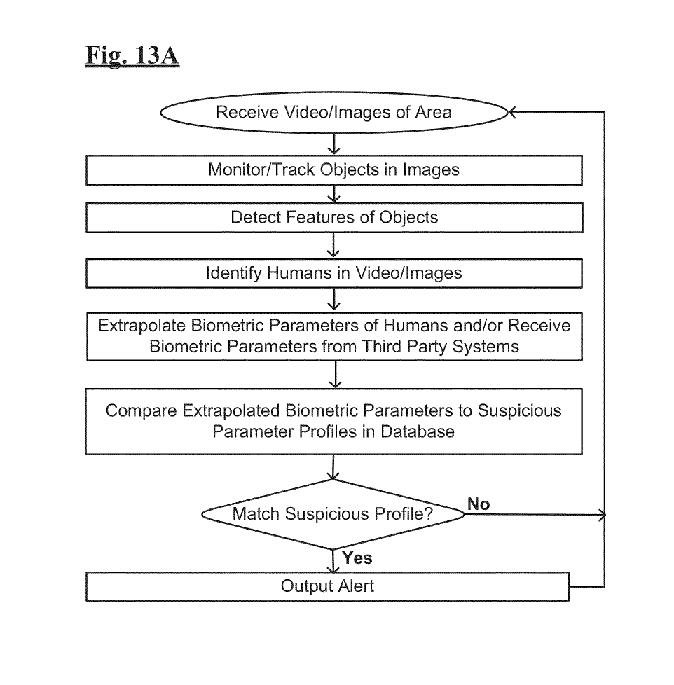

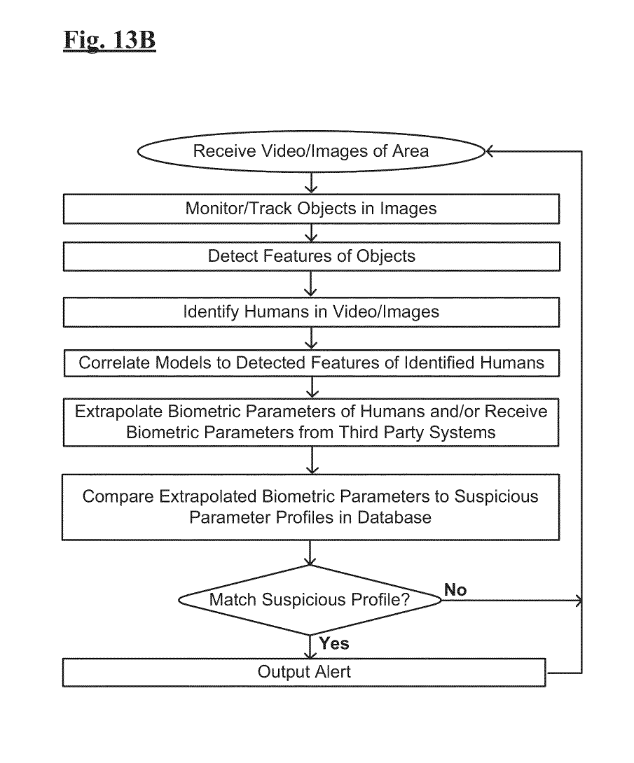

Referring to FIGS. 7-8, 11A-11B and 13A-13B, according to some embodiments, an area may be monitored by an IBBE system to identify individuals exhibiting suspicious biometric profiles or otherwise interesting biometric profiles. Such systems may monitor the area, either via native image/video sensors or via third party sensors or monitoring systems, extrapolate biometric profiles of humans detected in the area and compare these profiles to reference suspicious/interesting profiles. When a suspicious/interesting biometric profile is detected an alert may be issued to the appropriate party. According to further embodiments, the opposite may be performed, i.e. standard/normal behavior reference profiles may be compared to and individuals exhibiting a biometric profile sufficiently deviating from the norm identified. Obviously, both methods may be employed in the appropriate situations, i.e. individuals having biometric profiles matching a suspicious/interesting reference profile identified and individuals having biometric profiles deviating from a standard/normal reference profile identified. Exemplary Block diagrams of such systems are illustrated in FIGS. 11A-11B and exemplary steps of their operation are shown in FIGS. 13A-13B. As can be seen in FIGS. 13A-13B, such a monitoring IBBE system may monitor objects appearing in images/video received from the sensors, detect features of the objects and determine which objects are humans. Once a human is detected the IBBE system may extrapolate Static Biometric Parameters of the human, possibly by use of models, (e.g. skeletal models), as described herein. The system may further track one or more of the detected features over a series of frames to extrapolate dynamic biometric parameters of the individual. The system may then extrapolate biometric profiles of detected humans (static and/or dynamic) and compare the extrapolated profiles to reference suspicious/interesting/normal profiles stored in an associated database. According to some embodiments, comparison to reference profiles may be performed in stages, as described herein. For example, the IBBE system may first compare a one type of biometric parameter to biometric profiles to reference profiles, to identify a group of reference profiles matching the first type of extrapolated biometric parameter. The system may then compare one or more of the other types of extrapolated biometric parameters to the identified group of profiles to find a match. The system, when a match or lack thereof (in the case of use of a normal reference profile) is found, may output an appropriate alert and may further track the suspicious/interesting subject and output the continued location and/or biometric profile of the individual. In such systems, the IBBE system may only extrapolate a specific set of biometric parameters needed for the specific purpose.

An example of the function of such an IBBE system is illustrated in FIG. 7. As can be seen, an audience listening to a speaker is presented. The area is monitored by image/video sensors associated with an IBBE system. Further illustrated are examples of individuals identified as suspicious based on their biometric profiles. One, on the lefthand side, is identified as suspicious due to his clothing and his rapid movement towards the crowd. This individual may also be identified as exhibiting biometric parameters typical of a man about to commit an act of violence (e.g. head position and closed fists). The second example of individuals identified as suspicious based on their biometric profiles (on the right) have been identified as suspicious due to one passing a briefcase to the other. Again, other biometric parameters may have been considered in this identification.

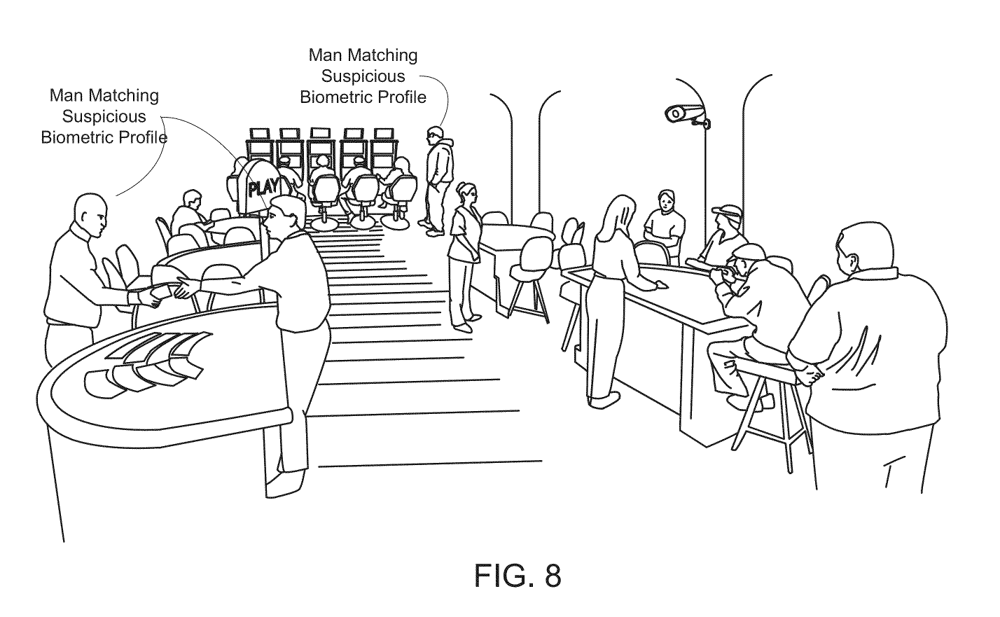

Another example of the function of such an IBBE system is illustrated in FIG. 8. As can be seen, a Casino floor scene is presented. The area is monitored by image/video sensors associated with an IBBE system. Further illustrated are examples of individuals identified as suspicious based on their biometric profiles. One, on the lefthand side, is identified as suspicious due to his passing something to a dealer (which is not allowed in a Casino). The second example of an individual identified as suspicious based on his biometric profiles (on the top) has been identified as suspicious due to his clothing and his extended surveillance of gamblers at the slots without playing himself. Again, other biometric parameters may have been considered in this identification. In another example, positions and behaviors of individuals using automated machines (e.g. slot machines, ATM's, Pachinko machines, vending machines, automated gas pumps, etc.) may be monitored by an IBBE system to identify individuals exhibiting suspicious/malicious/criminal behavior. For example, an individual hitting, moving or otherwise vandalizing the machine could be identified and an appropriate alert issued. Such a system could be programmed to immediately identify certain classic misuse behaviors associated with the specific machine (e.g. an individual inserting his/her hand into a vending machine from the bottom area could immediately be identified, or an individual using both hands together on a slot machine or Pachinko machine could immediately be identified. In another example one or more “normal” reference biometric profiles of individuals using the machine may be compared to, such that any individual using the machine having a biometric profile outside the “normal” range is identified. For example, certain machines may normally be used with one hand, therefore an individual using two hands on the machine may be identified as suspicious.

Yet another example of the function of such an IBBE system may be the monitoring of a retail establishment. In such systems, biometric profiles of customers and employees may be monitored, possibly by using standard/existing surveillance cameras. Once a human is detected in the retail establishment, the IBBE system may extrapolate Static Biometric Parameters of the human, possibly by use of models, (e.g. skeletal models), as described herein. The system may further track one or more of the detected features over a series of frames to extrapolate dynamic biometric parameters of the individual. The system may then extrapolate biometric profiles of detected humans (static and/or dynamic) and compare the extrapolated profiles to reference suspicious/interesting/normal profiles stored in an associated database. For example, customers placing merchandise in their pockets or bags may be immediately detected. Further, employee and customer behavior at points of sale can be monitored to detect suspicious behavior (e.g. Sweethearting, tempering, return fraud, skimming, etc.). Such a system may issue alerts when detecting suspicious behavior (suspicious biometric profiles) and/or may mark the time and location of the suspicious event to facilitate efficient review of surveillance footage by appropriate personnel.

According to further embodiments, an IBBE system may interact and receive data from other relevant systems and use this data to determine certain events. For example, an IBBE system monitoring a retail establishment may also receive data from the retail establishment's registers. In such embodiments, the IBBE system may compare visual data to the register data to identify different forms of fraud, e.g. a person identified in the video as leaving the store with a diamond while the register has charged for an apple may be identified by the system. Similarly, if 3 persons are viewed entering a concert while only one ticket is charged at the register an alert may be issued.

Some examples of known methods for stealing from retail establishments are presented below, along with methods by which an IBBE system may detect such acts:
a. Under-ringing—The cashier scans an item at less than its listed price, collects the full amount, and steals the extra money. To cover the fraudulent act, the cashier fails to provide a receipt or blocks the cash register display window from the customer.—this act can be detected by detecting that an item was not passed under a bar scanner properly, or by comparing video footage to register data, as explained above;
b. Sweethearting—Cashiers give free merchandise or discounts to family and friends without proper authorization. For example, a cashier at a Macy's store was caught intentionally not scanning items for her mother and sister at her register.—this act can be detected by detecting that an item was not passed under a bar scanner properly, or by comparing video footage to register data, as explained above;
c. Refund Fraud—The cashier rings up a false refund and takes the money, in effect causing the theft of cash to appear as an inventory shortage. The employee might also choose to prepare a false refund voucher. In this scheme, the document usually contains a fake name and address to make it appear as if a customer has returned a product.—this act can be detected by detecting scanning of an item when no customer is present, Detecting cash from the cash drawer moved to anywhere other than the customer's hand or the counter and/or by comparing video data to register data, as explained above;
d. Fraud by Voids—Voids are similar to refunds in that they cancel a sale. To process a fraudulent void, the cashier keeps the customer's sales receipt. The cashier is now able to ring the item up as a voided sale and takes out the cash from the register, making it appear as if the money has been returned to the customer rather than stolen. A void slip that requires a manager's signature for verification is attached to a copy of the customer's receipt. In many cases, however, managers fail to recognize a fraudulent void—such acts can be detected similarly to detection of Refund Fraud;
e. Unauthorized Discounts—Cashiers have the ability to redeem coupons for customers and to process employee discounts at registers. Cashiers can abuse this access without proper controls in place, often by bypassing required manager approvals. Cashiers also often abuse employee discounts by selling items to friends at a lower price so that they can attempt to return the item for a full refund at a different location without a receipt—such acts can be detected by comparing video data to register data and/or by identifying suspicious biometric profiles of cashiers;
f. Training mode—in some establishements, managers have the authority to program the cash register so that sales are not recorded during the process of training new employees. Abuse of this function takes place when actual sales are allowed under the training mode and the undocumented transactions are pocketed at the end of a shift.—such acts can be detected by detecting that customer presence or payment while the cashier is in training mode;
g. Shoplifting—well known—simply removing items from the establishment without paying. Such acts can be detected by detecting that a customer moves any product without passing through the bar scanner;
h. Credit Card Fraud—The cashier is scanning the customer's credit card for using it illegally. This is usually done in a hidden location under the checkout table. Such acts can be detected by monitoring a cashiers hand when handling credit cards and/or by monitoring movements of the credit card;
i. Bottom of Basket—Items left at the customer's shopping cart without being scanned and paid for.—such acts can be detected by monitoring carts when they pass by the registers to make sure they are empty;
j. Unmanned Point of Sale (POS) Tampering—The customer manipulating POS components (the cash drawer, keyboard or touch screen) when the checkout is unmanned—such acts can be detected by monitoring customers hands when in proximity to POS components;\
   It should be understood that the above list is presented for demonstration purposes only, and that many other such schemes/methods can be similarly implemented using the similar logic.

According to further embodiments, other behaviors monitored at a POS may include: (1) Checkout manned—Cashier arriving at checkout and sitting at position, (2) Checkout unmanned—Cashier leaving checkout position, (3) Customer present—A customer standing at the checkout lane, (4) no customer present—No customer at the checkout lane, (5) Erratic cashier—Cashier turning and moving excessively in the chair, and (5) Hidden hand(s)—Cashier hands are not fully visible.

According to some embodiments, any subject exhibiting a biometric profile sufficiently distinct/deviating from normal biometric profiles may be monitored, an alert may be sent to the appropriate party and/or the relevant section of the video footage may be marked for review. In this manner, as people committing unlawful/improper acts tend to behave/move/stand differently than normal people, unlawful/improper acts may be identified.

From the above examples, it can be understood that suspicious biometric profiles may be situation and/or area specific—what is considered suspicious at a casino may not be suspicious at a social gathering and vice versa and what may be suspicious at a dentist conference may not be suspicious at a nightclub, etc. Equally, suspicious biometric profiles may be gender and/or age specific, time specific, geographically specific, ethnic specific and so on. Further, as hinted above, interesting profiles may not necessarily be interesting due to suspicion. For example, in the casino scene, a proprietor of the system may also wish to identify biometric profiles of high-rollers or celebrities. According to embodiments of the present invention, any set of biometric parameters indicative of an individual which is desired to be identified may be stored in an IBBE system database as a reference profile, such that any individual matching the profile appearing in an area monitored by the IBBE system will then be identified by the system. Such a reference profile may be indicative of a specific individual (such as in the bank robber example) or indicative of a class or characteristic of individuals (such as in the casino example).

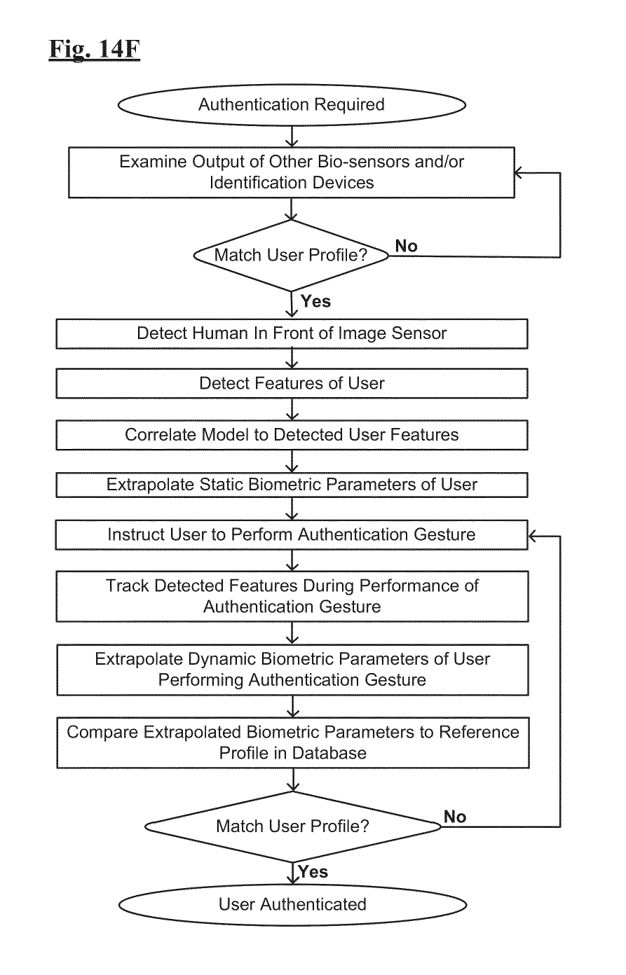

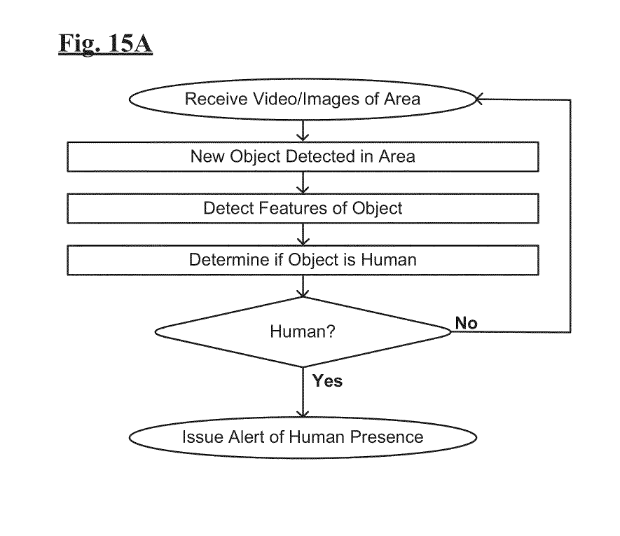

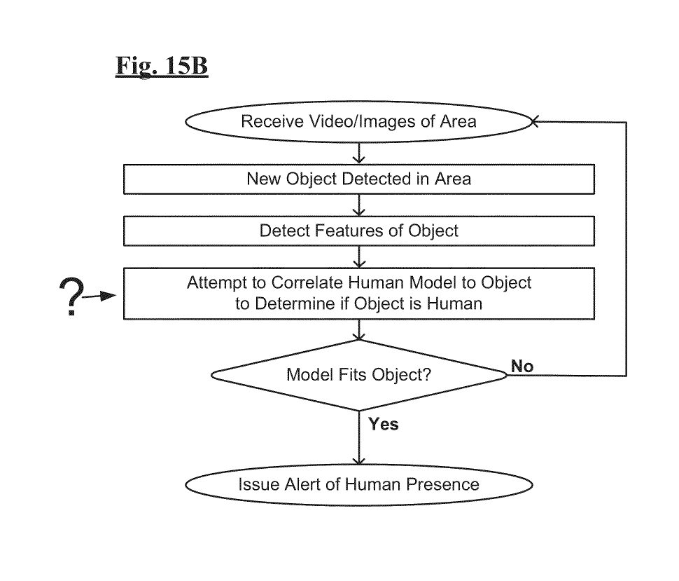

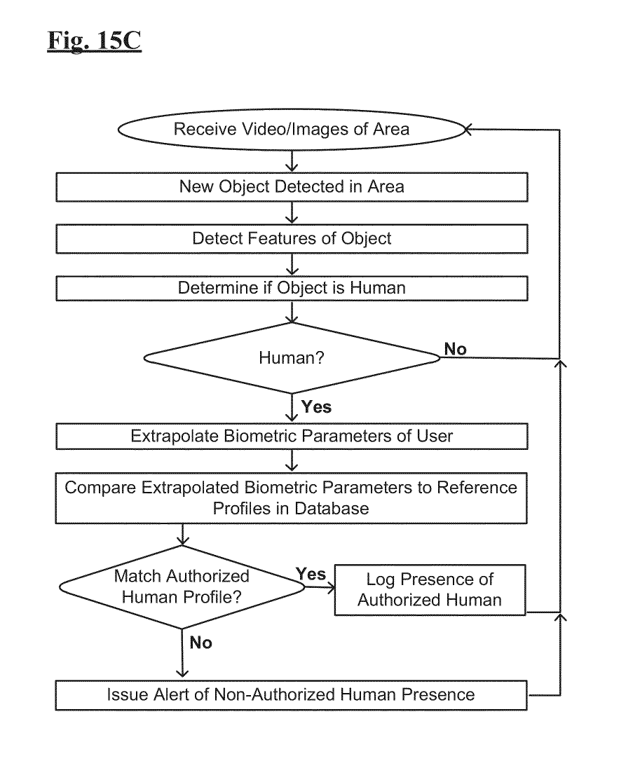

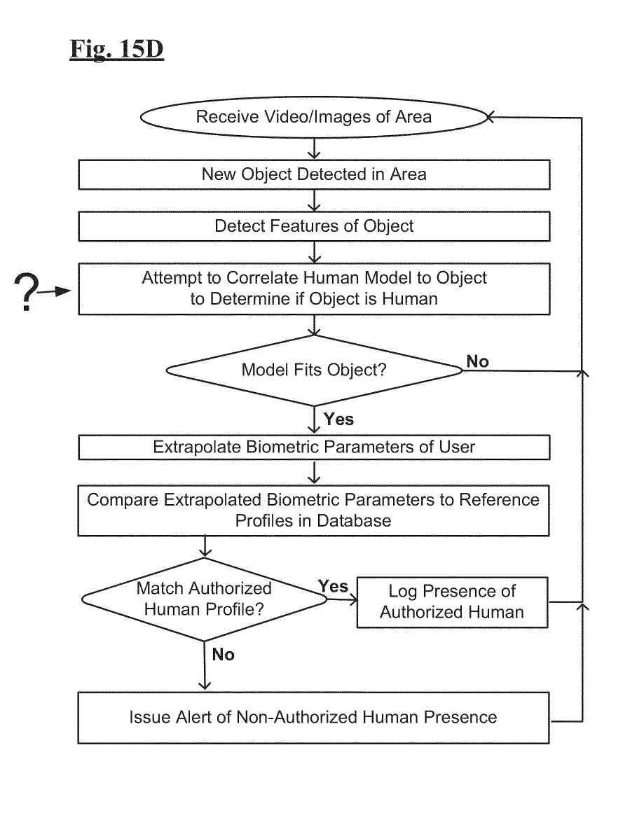

Is some circumstances, it may be desirable to implement an IBBE system to alert of any human presence in an area, or of any human presence other than a given list of humans authorized to be in the area (e.g. in home security). FIGS. 15A-15D present exemplary steps of operation of IBBE systems used for such purposes. As shown in FIGS. 15A-15B, such IBBE monitoring systems may analyze video/images of the monitored area and detect new objects appearing in the area. When new objects are detected in the area the system may detect features of the objects to determine if they are human, possibly by use of models. If a human is detected, the IBBE system may issue an appropriate alert. According to further embodiments, exemplified in FIGS. 15C-15D, the IBBE system, when detecting a human presence, may proceed to extrapolate biometric parameters of the detected human, derive a biometric profile and compare the derived profile to reference profiles of humans authorized to be in the area. If the profile matches an authorized profile the system may log the presence of the authorized human and continue monitoring, whereas, if there is no matching profile (or the match is incomplete/uncertain) the IBBE system may then issue an alert of the unauthorized presence. For example, in the case of home security, members of the household may be authorized (and their biometric profiles stored as authorized humans), such that whenever a human presence is detected which exhibits biometric parameters that do not match a member of the household, an alert is issued by the system. Such a system can greatly improve the function of a home security system by mitigating the occurrence of false alerts, when a member of the household forgets the alarm and enters a monitored area or false alerts caused by pets or moving branches. This may also allow the system to be active even when the occupants of the house are home, as only foreign presences will activate the alarm.

According to some embodiments, comparison of biometric profiles of individuals to reference biometric profiles may be divided into 6 categories:
a. One to one comparison—one individual's biometric profile is compared to one reference profile, such that a result of the comparison can be either: (1) positive match, (2) partial match, or (3) negative (no match). This category of comparison is appropriate for authentication purposes, i.e. is the individual who he claims to be?;
b. One to many comparison—one individual's biometric profile is compared to a group of reference profiles in an attempt to correlate the individual to one of the group of reference profiles, such that a result of the comparison can be either: (1) positive identification, (2) partial match/identification, or (3) negative (no match). This category of comparison is appropriate for identification purposes, i.e. is the individual one of the individuals referenced by the group and if so, which one?
c. Many to many comparison—multiple individual's biometric profiles are compared to multiple reference profiles in an attempt to correlate each of the individuals to one of the group of reference profiles, such that a result of the comparison can be either: (1) a set of one or more positive identifications, (2) a set of one or more partial matches/identifications, (3) negative (no matches) or (4) a combination of the above. This category of comparison is appropriate for monitoring/tracking purposes, i.e. who are the one or more the individuals? And monitor/track them;
d. Many to one comparison—multiple individual's biometric profiles are compared to a single reference profile in an attempt to correlate one of the individual's to the reference profile, such that a result of the comparison can be either: (1) positive identification of one of the individuals, (2) partial match/identification of one of the individuals, or (3) negative (no match). This category of comparison is appropriate for tracking/searching purposes, i.e. is the individual I am looking for present in the group and if so, which one is he?;
e. Many to all—multiple individuals' biometric profiles are compared to all reference profiles in an attempt to correlate each of the individuals to a reference profile, such that a result of the comparison should be a positive or partial identification of each individual. In this type of comparison, a new reference profile is created for each individual not matching an existing profile. This category of comparison is appropriate for monitoring purposes, i.e. identify and track each individual in the group; and
f. One or many to categories—one or multiple individuals' biometric profiles are each compared to a group of reference category profiles in an attempt to correlate each of the individuals to one or more of the categories, such that a result of the comparison should be a categorization of each of the individuals. This category of comparison is appropriate for categorization purposes and statistical analysis, i.e. what category does each of the individuals belong to and how many of each category?

Referring to FIG. 5, according to some embodiments, one or more BPSMP of a walking pattern of a subject may be extrapolated from a video sequence [see FIG. 5]. It should be noted that a body/head of a human walking typically moves in a spiral pattern, going up and down and left to right simultaneously in a cyclic motion as the person walks, as exemplified in FIG. 5. This motion can be tracked, by tracking one or more points on the subject's body/head, as the subject walks. Accordingly, one or more BPSMP's of a walking pattern of a subject may include one or more of:

a. a max/min height of the subject when walking, as illustrated in FIG. 5;

b. an amplitude and/or frequency of the spiral pattern;

c. a shape of the spiral pattern;

d. an amplitude and/or frequency of the sideways motion of the subject when walking;

e. a speed of progression; and

f. relations between one or more of the above parameters;

g. any other parameter of the spiral pattern.

Furthermore, characteristics of a subjects spiral pattern when walking may indicate a mood/intention/state of the subject. For example, a man angry and determined may exhibit specific types of patterns discernable from regular walking patterns which may be used to identify subjects about to commit a crime of violence.

It can further be noted that hands/arms of a human walking typically move when the human is walking, going forward and back along the subject's side as the subject walks, as illustrated in FIG. 5. Accordingly, one or more BPSMP's of a walking pattern of a subject may include one or more of:

a. a max/min height of the arm/hand when walking, i.e. amplitude of the motion;

b. a frequency/speed of the arm/hand motion;

c. angles between the arm/hand and other body parts in different stages of the motion;

d. positions of the palms and their relations to the arm in different stages of the motion;

e. joint positions and angles during the motion;

f. a relationship between the arm/hand motion and the other bodily motions;

g. relations between one or more of the above parameters; and/or

h. any other parameter of the arm/hand motion.

According to some embodiments, BPSMP's of a walking pattern of a subject appearing in a video may be used to identify a subject by comparing the BPSMP's to reference BPSMP's of walking pattern of subjects stored in a reference database, either alone or in concert with other parameters associated with the subject. According to further embodiments, BPSMP's of a walking pattern of a subject may be used to track the subject when moving through an area including multiple video acquisition subsystems, e.g. in an airport [see FIG. 7].

Referring to FIGS. 3 and 6, according to some embodiments, one or more BPSMP's of one or more gestures of a subject may be extrapolated from a video sequence and used to identify and/or authenticate a subject. For example, one or more BPSMP's of a hand waving motion of a subject may be used to identify/authenticate the subject, alone or in concert with other identification/authentication parameters, as illustrated in FIG. 6. It should be understood that the following description is presented in relation to a hand waving motion by way of example and that any other gesture may be equally used with the appropriate modifications. One or more BPSMP's of a hand waving of a subject may include one or more of:
a. an amplitude and/or frequency of the waving motion, i.e. distance of movement and speed of movement;
b. a shape/pattern of the hand motion, e.g. arced, elipsoid;
c. locations of the arm and palm in relation to the body during the motion, e.g. height in relation to shoulder, angle of the elbow during stages of the motion;
d. finger and palm positions during the motion;
e. joint positions and angles during the motion;
f. relations between hand and arm movements;
g. relations between one or more of the above parameters; and
h. any other parameter of the gesture.

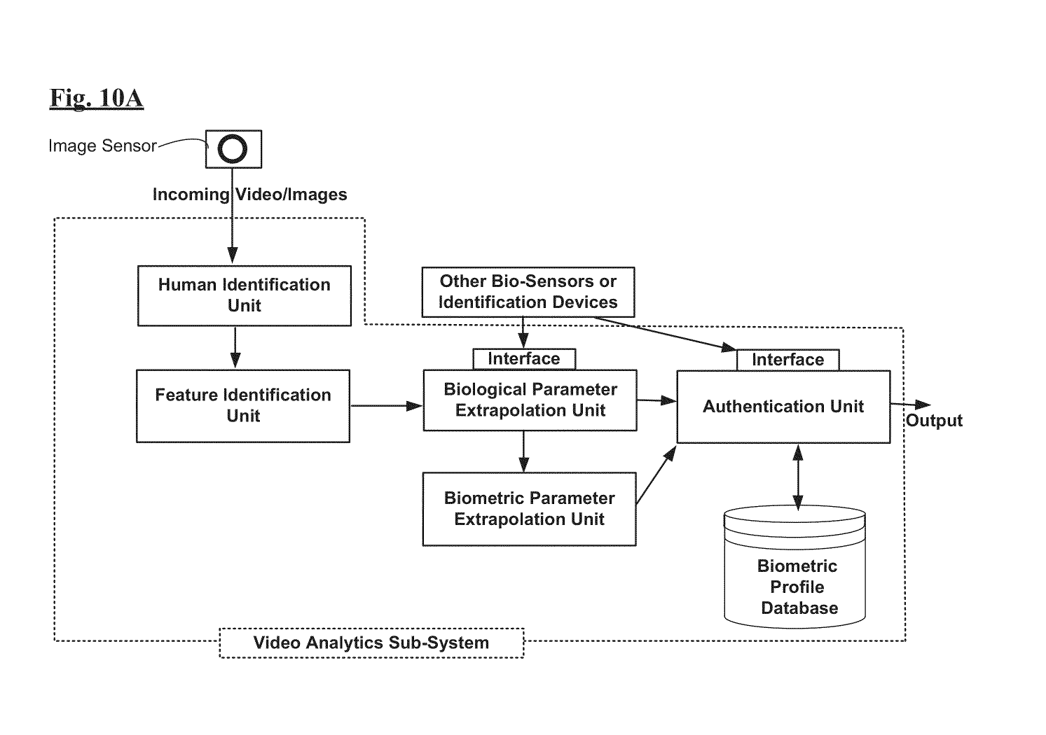

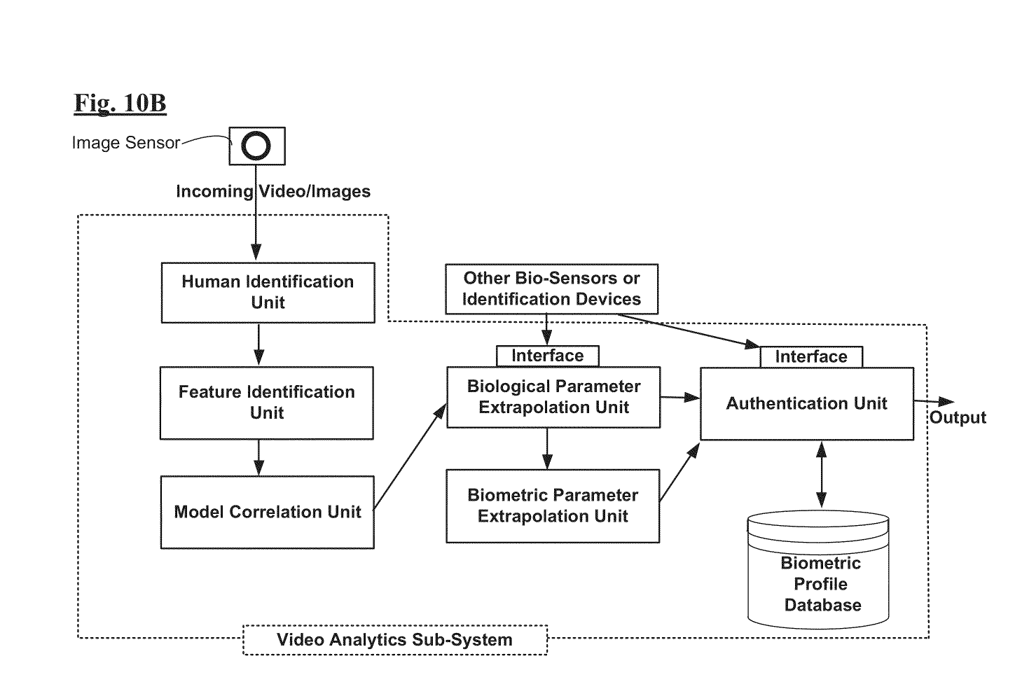

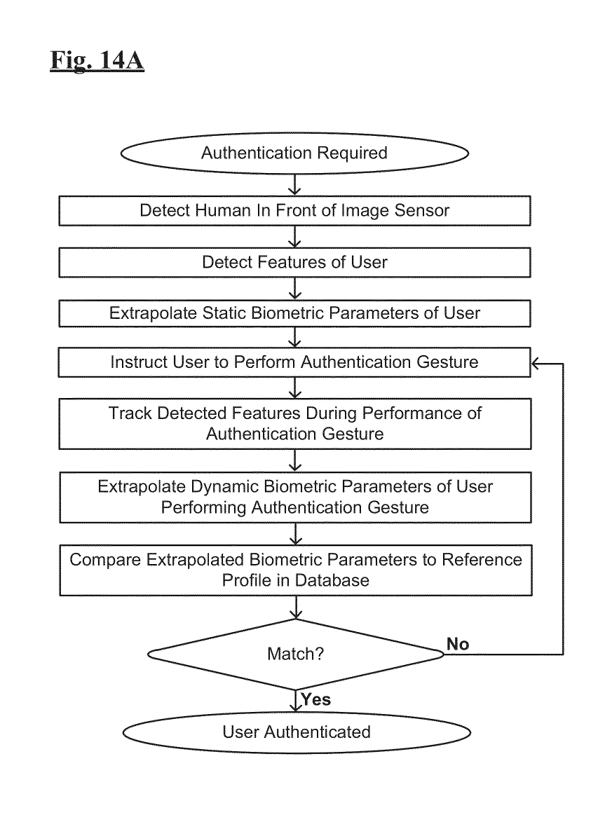

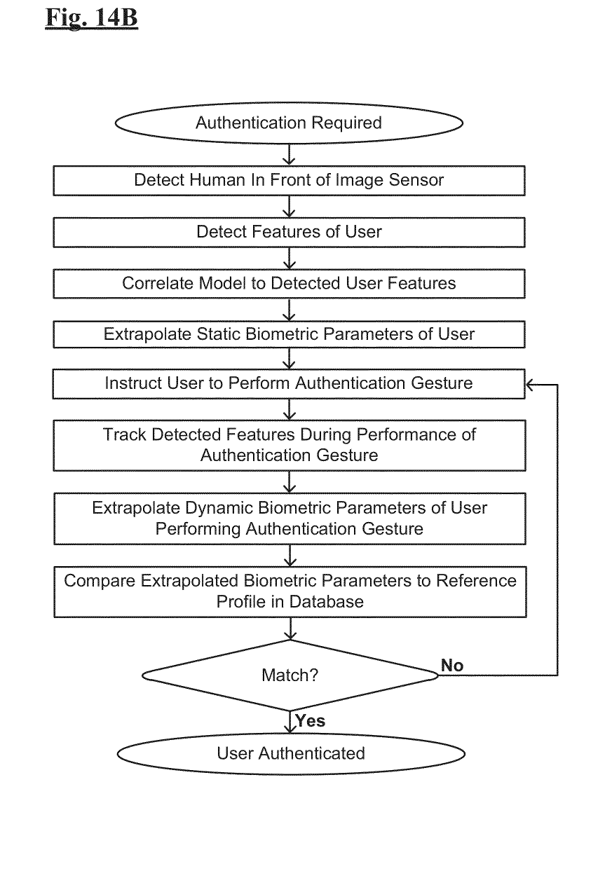

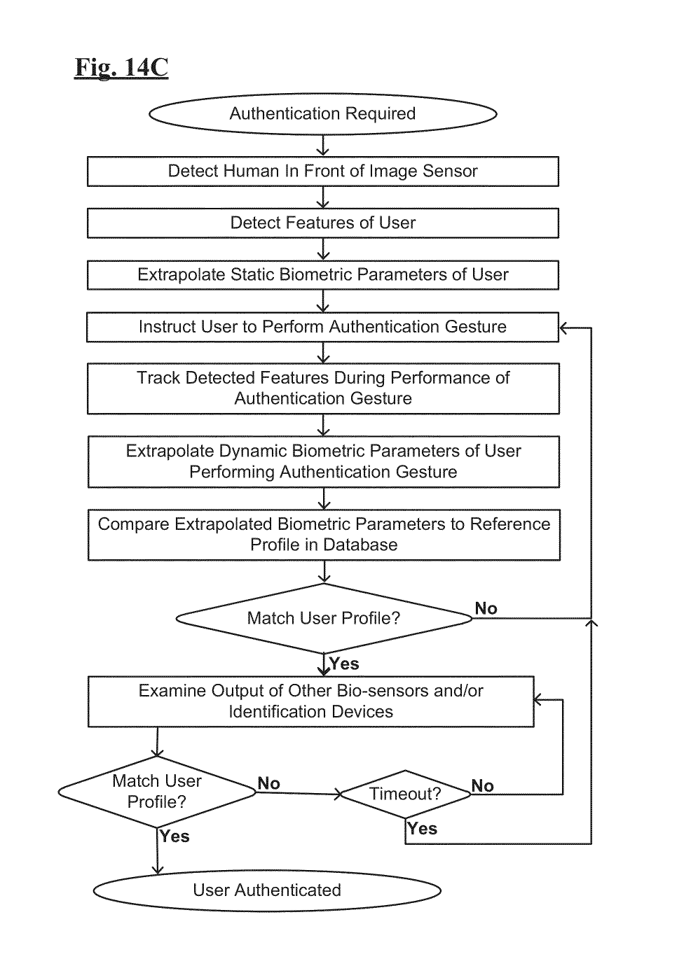

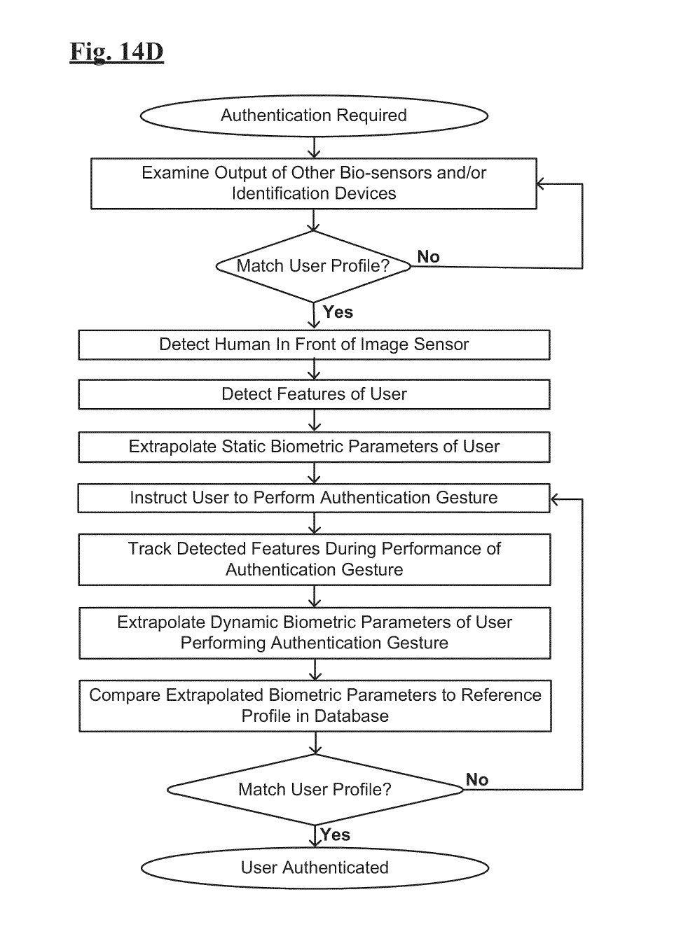

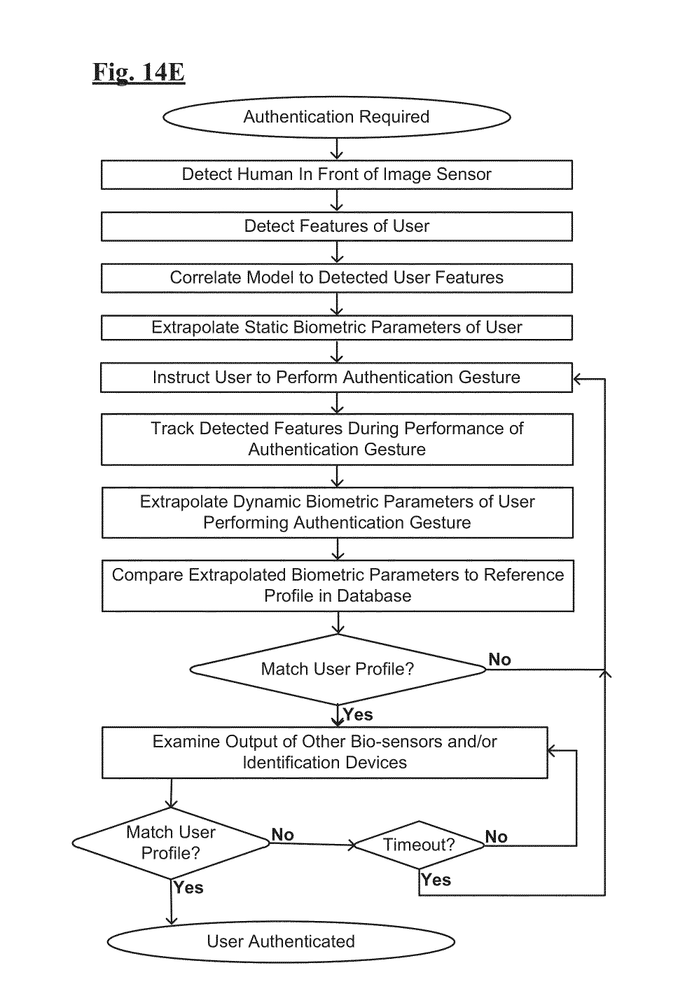

According to some embodiments, there may be provided a biometric based authentication system which may include IBBE functionalities and may authenticate a subject by comparing one more BPSMP's of the subject to a record or table of records of reference BPSMP's of registered/permitted users/subjects [see FIGS. 3, 6, 10A-10B and 14A-14F]. Such a system may include an image sensor (e.g. webcam), as illustrated in FIGS. 10A-10B, or may be functionally associated with such a sensor. As shown in FIGS. 14A-14F, a biometric based authentication system, when authentication is required, may first detect a human subject in the view of an associated image/video sensor, then detect features of the subject and possibly proceed to extract Static Biometric parameters of the user, possibly by use of models (e.g. skeletal models). The user may then be requested to perform an authentication gesture before the image/video sensor. The IBBE authentication system may track one or more of the detected features of the user/subject as the user/subject is performing the authentication gesture to extrapolate dynamic biometric parameters of the user/subject performing the gesture. FIG. 6 illustrates examples of extrapolation of dynamic biometric parameters of a user performing an authentication gesture, as explained in further detail herein. Finally the IBBE authentication system may compare the extrapolated biometric parameters (static and/or dynamic) to reference biometric profiles of authorized user(s) in an associated database. If the parameters match to a sufficient degree, the user can be authenticated by the IBBE authentication system. If there is no match, the user is not authenticated and may be requested to perform the authentication gesture again. As with other such systems, there may be a limit to the number of times the system allows the user to perform the authentication gesture and/or there may be a delay between attempts. According to further embodiments, as shown in FIGS. 14C-14F, an IBBE authentication system may work in conjunction with other bio-sensors (e.g. fingerprint sensor) and/or other authentication devices (e.g. PIN input device), to provide multi-factor authentication. In such systems, the “other” authentication may be performed prior or in parallel to the IBBE authentication, as shown in FIGS. 14D & 14F, or the “other” authentication may be performed subsequent to the IBBE authentication, as shown in FIGS. 14C & 14E. In such embodiments, in which IBBE authentication is performed first, there may be a timeout period after IBBE authentication, in which the user must complete the “other” authentication, or the user may be requested to repeat the authentication gesture. The biometric based authentication system may extrapolate BPSMP's of the subject from received images and compare them to reference BPSMP's of registered/permitted users/subjects to verify the subject is permitted access to the requested resource, i.e. authenticate the user. For the purpose of authentication the subject may be required to perform one or more gestures or motions from which the system may extrapolate the relevant BPSMP's. For example, the subject may be required to wave to the camera when attempting authentication, as illustrated in FIG. 3. According to further embodiments, a biometric based authentication system may interact with another type of authentication system or process to supplement the other authentication process [see FIGS. 14C-14F]. For example, a subject waving to the camera may also be required to enter a password to provide for multi-factor authentication.

According to further embodiments, an IBBE authentication may implement passive biometric detection for authentication. In such IBBE systems, the IBBE authentication system may detect humans approaching or in front of an associated computational platform requiring authentication, detect features of these humans, extrapolate static biometric parameters of these humans (possibly by use of models) and further track the detected features during motions of these humans to extrapolate dynamic biometric parameters of their motion (e.g. extrapolate dynamic biometric parameters of their walk as they approach the system). The extrapolated biometric parameters may then be compared to reference biometric profiles of authorized users to authenticate the user (in the event of a match) or deny access (in the event there isn't a match). For example, the approach to a particularly sensitive terminal in a facility may be monitored by an IBBE authentication system, which may extrapolate biometric parameters of people approaching the terminal and compare the extrapolated parameters to reference biometric profiles of users authorized to use the terminal. In this fashion, by the time the user reaches the terminal the terminal will already “know” if the user is authorized or not.

According to some embodiments, the systems and methods described herein may be used to determine static and dynamic biometric parameters of tracked subjects in an area and compare the determined biometric parameters to a reference of natural ranges of motion parameters of humans. Thereby, subjects exhibiting unnatural motion parameters may be identified. Often times persons with unlawful or malicious/suspicious intentions will exhibit unnatural motion parameters. In this fashion, such individuals can be identified in a group of people and the appropriate authorities alerted. This feature can be especially useful in monitoring of areas containing large groups of people, e.g. airports, large events, public speeches, etc. Alternatively, subjects exhibiting unnatural behavior may be identified and further analysis performed in relation to the identified subjects and their biometric parameters to determine if the identified subjects are actually suspicious.

The present disclosure is described in relation to human identification/tracking/monitoring. It should be understood, however, that the principles, components and methods described herein can also be implemented in relation to other objects (e.g. motor vehicles on a road or animals in a zoo) with the appropriate modifications.

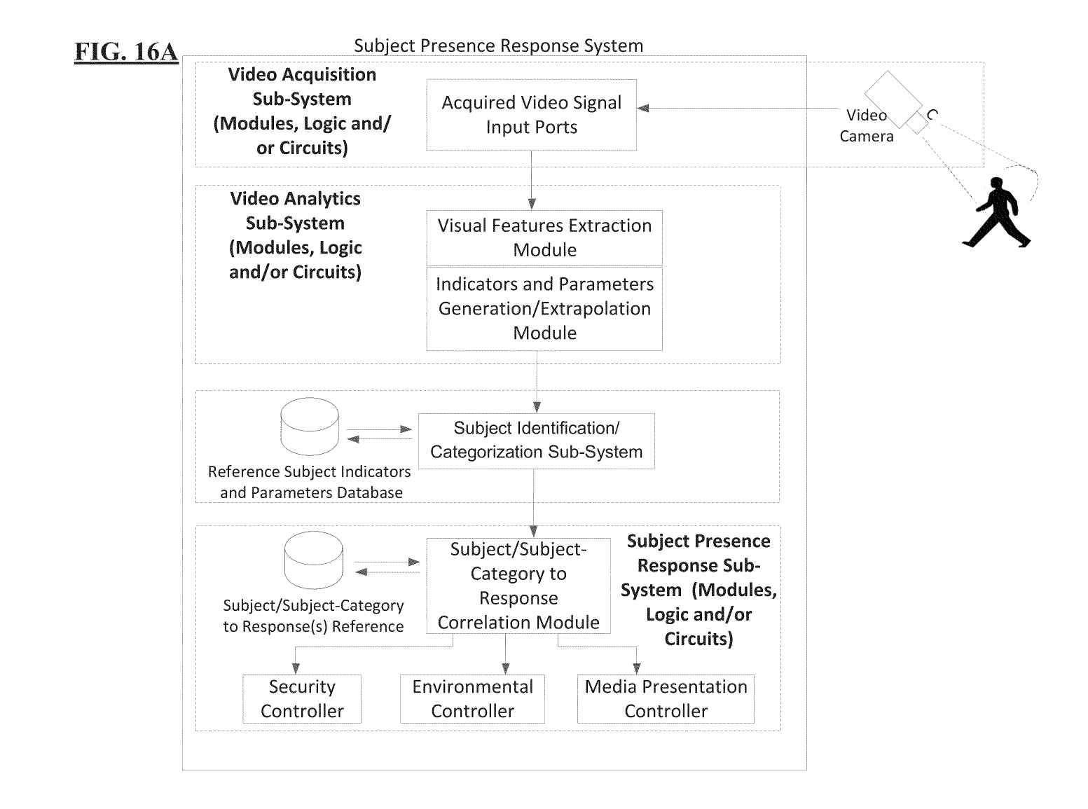

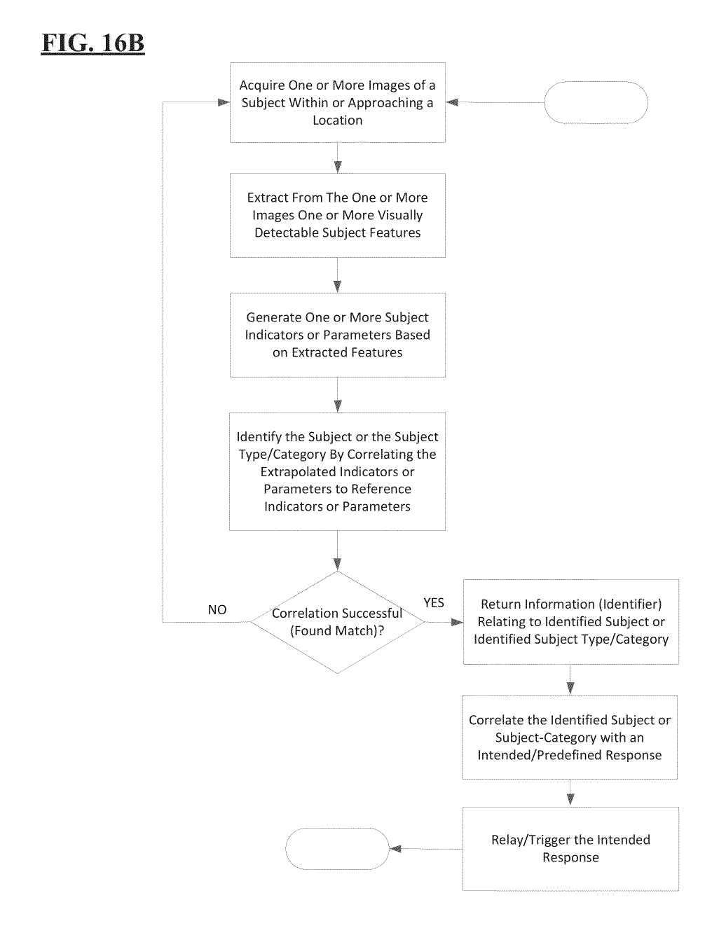

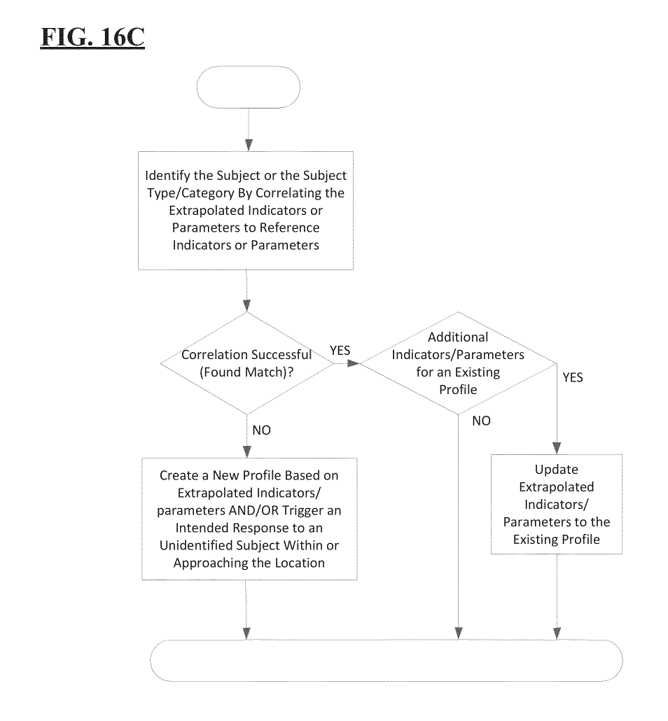

Turning now to FIG. 16A, there is shown a functional block diagram of an exemplary video based subject presence response system according to some embodiments, including a video acquisition sub-subsystem, video analytics sub-system, a subject or category identification sub-system, and a subject response sub-system. Operation of the system of FIG. 16A may be explained in conjunction with FIG. 16B, which is a flowchart including exemplary steps of a generic method of operation of a Subject Presence Response System (SPRS) according to some embodiments, wherein the generic operation includes video analytics to extract static and/or dynamic visually detectable features (biometric parameters) of a subject in a video sequence, referencing of a subject/category indicator database in order to identify or categorize the subject, and referencing a subject/category reference database in order to respond to identification or categorization of the subject in an acquired video sequence. More specifically, the video analytics sub-system may employ one or a set of image processing algorithms to extract features from one or more frames of a video sequence. Certain algorithms may identify per frame subject features such as head, shoulders, arms, legs, etc. on a frame by frame bases, while other algorithms may track the movement of specific subject features across consecutive frames. Non-motion related subject features may be referred to as static features (Static biometric parameters), while movement related features may be referred to as dynamic features (Dynamic biometric parameters).

The analytics sub-system also includes a subject indicator generation module adapted to analyze one or more static and/or dynamic features of a subject and to quantify the features into one or more subject indicators. A subject identification/categorization sub-system may then use the indicators generated for subject in a video sequence to reference a database include indicator sets associated various individuals and/or various type/categories of individuals. A subject presence response sub-system may reference an identified individual subject or category of subjects in a database in order to determine a response to trigger due the subject's presence in the video sequence.

Turning now to FIG. 16C, there is shown a flowchart including exemplary steps of a subject registration method of a Subject Presence Response System according to some embodiments, wherein the registration operation may include video analytics to extract static and/or dynamic visually detectable features (Static and/or dynamic biometric parameters) of a given subject, updating one or more records relating to the given subject with the extracted features (biometric parameters), updating one or more records in a subject/type profile database with data indicative of a response to be triggered upon future detection of the given subject. In situations when indicators derived from a video sequence do not fully correlate or fully match up with reference indicators in a reference data base, the system may either create completely new records for a new individual subject and/or may update or append indicators to an existing subject's records.

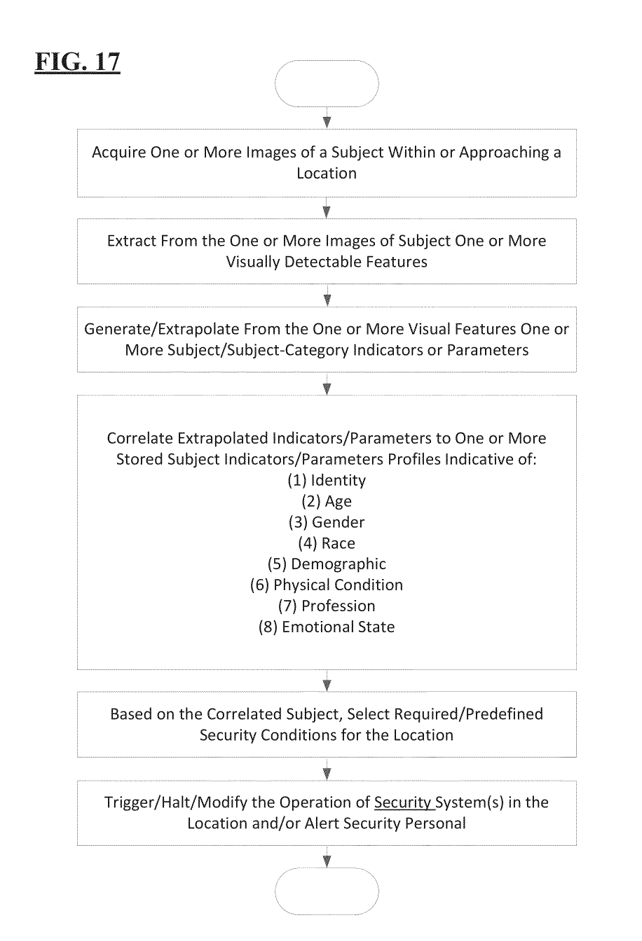

Turning now to FIG. 17, there is shown a flowchart including exemplary steps of a security related operation of a Subject Presence Response System (SPRS) according to some embodiments, wherein the operation may include video analytics to extract static and/or dynamic visually detectable features (Static and/or Dynamic biometric parameters) of a subject in a video sequence, generating subject indicators, referencing of an indicator reference database in order to identify or categorize the subject, and referencing a security profile database in order to respond to identification or categorization of the subject in the acquired video sequence. Options for responding may include: Issuing Alarm Signals, Disabling Alarm Systems, Reconfiguring Alarm Systems, Locking or Unlocking doors, tracking the subject and so on.

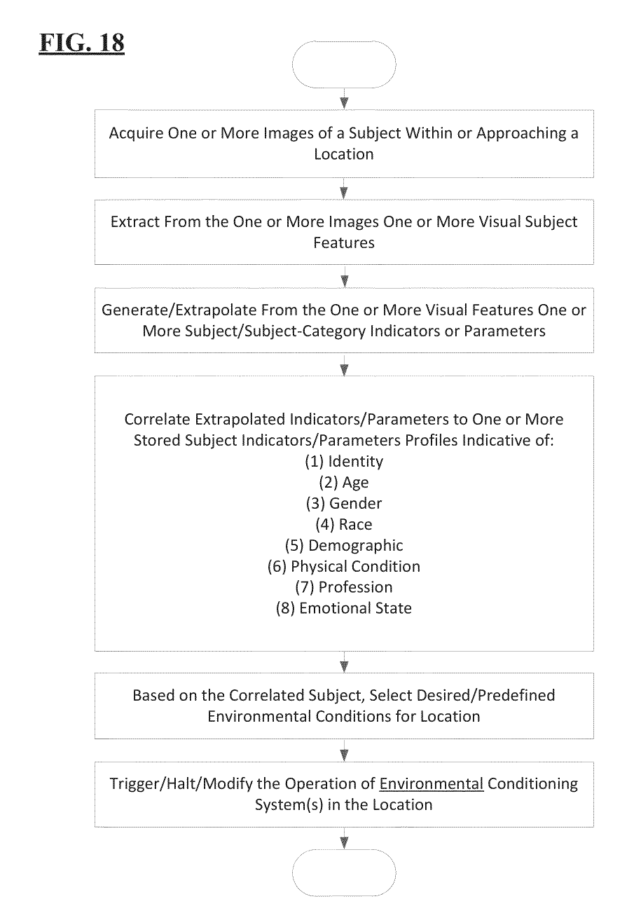

Turning now to FIG. 18, there is shown a flowchart including exemplary steps of an environmental related operation of a Subject Presence Response System (SPRS) according to some embodiments, wherein the operation may include video analytics to extract static and/or dynamic visually detectable features of a subject (Static and/or Dynamic biometric parameters) in a video sequence, generating subject indicators, referencing of an indicator reference database in order to identify or categorize the subject, and referencing an environment profile database in order to respond to identification or categorization of the subject in the acquired video sequence. According to some embodiments, environmental conditions such as lighting, temperature and/or background music may be triggered and/or altered based on identification of a specific individual having predefined specific environment preferences.

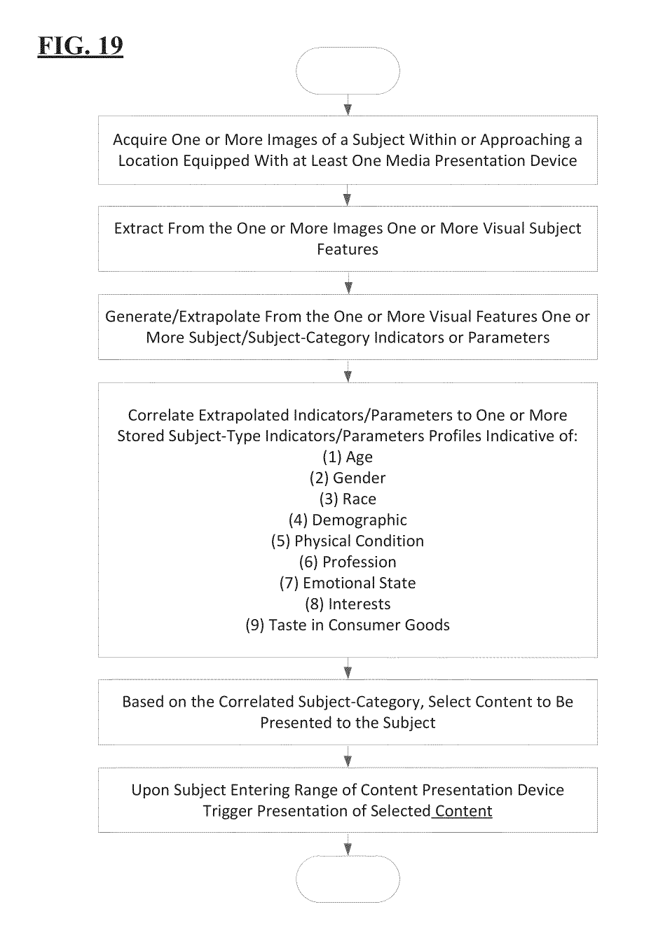

Turning now to FIG. 19, there is shown a flowchart including exemplary steps of a content presentation related operation of a Subject Presence Response System (SPRS) according to some embodiments, wherein the operation may include video analytics to extract static and/or dynamic visually detectable features (Static and/or Dynamic biometric parameters) of a subject in a video sequence, generating subject indicators, referencing of an indicator reference database in order to identify or categorize the subject, and referencing a content profile database in order to respond to identification or categorization of the subject in the acquired video sequence. According to some embodiments, identification of an individual may trigger the presentation of content predefined by the individual. According to further embodiments, identification of a subject belonging to some type or category of subjects may trigger the presentation of content, such as advertising or notifications, predefined by a third party, (e.g. an advertiser).

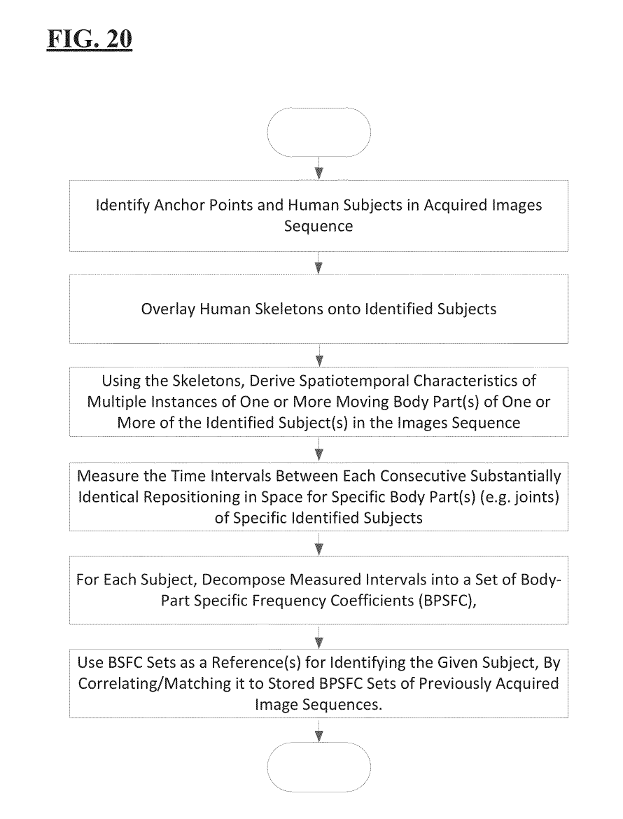

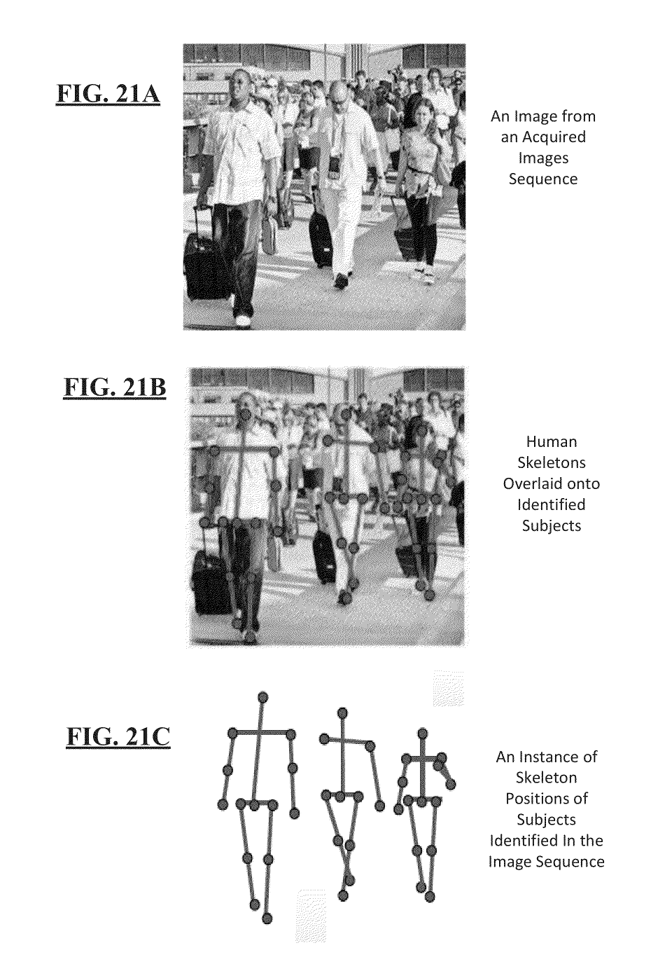

Turning now to FIG. 20, there is shown a flowchart including exemplary steps of a process by which: (1) static and dynamic features (biometric parameters) may be extracted from a video sequence, (2) subject indicators may be generated and used as or with reference indicators in accordance with some embodiments of the present invention. The steps of the FIG. 20 may be explained in conjunction with FIGS. 21A-21C, which show a series of images illustrating exemplary extraction of both static and dynamic subject features (biometric parameters) from a conventional surveillance video sequence, by use of skeletal models. This illustration shows a real implementation of the concepts portrayed in FIG. 1. As can be seen in these illustrations, a skeletal model is fitted by the system to each individual identified in the images. Static Biometric parameters of each individual can then be extrapolated from the fitted skeletal model and dynamic biometric parameters extrapolated by tracking movement of points on the skeletal model over a series of images.

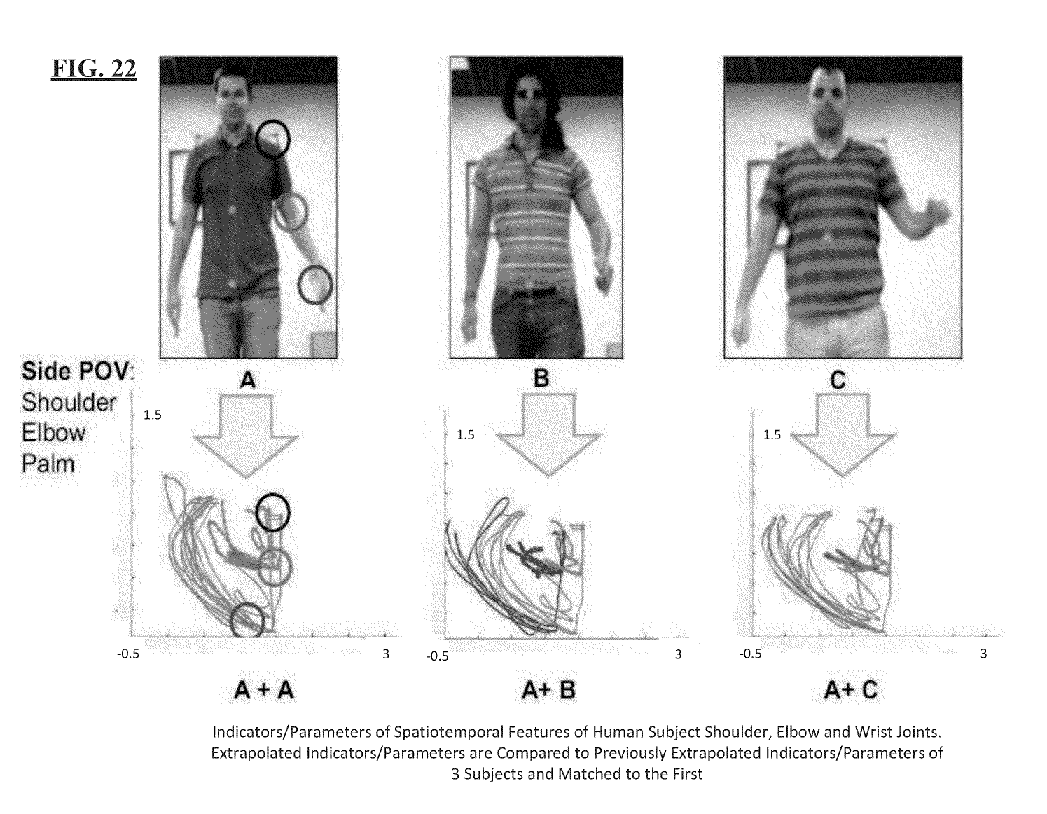

FIG. 22 shows a series of images illustrating an exemplary conversion of human movement captured in a conventional video sequence into Body Part Specific Motion Profiles.

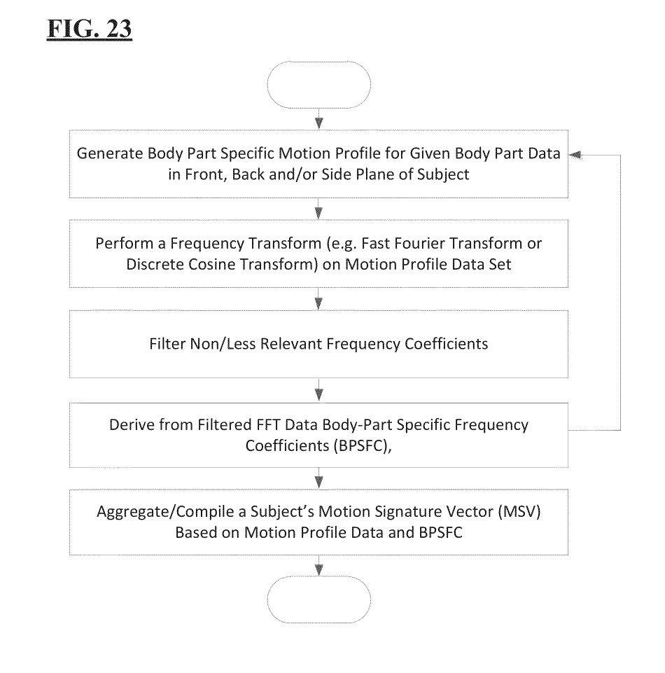

FIG. 23 shows a flow chart including exemplary steps of a process by which body part specific motion profiles may be converted into one or more sets of body part specific frequency coefficients and then aggregated into a Motion Signature Vector MSV for the subject comprised of BPSFC's grouped by body part.

According to some embodiments, there may be provided a video based subject response system including: (1) a video analytics module to extract subject features (biometric parameters) from an instance of a subject in a video sequence and to generate one or more subject indicators based on the extracted features; (2) an identification or categorization module adapted to correlate the generated one or more subject indicators with reference indicators in an indicator reference database, wherein specific sets of reference indicators are associated with either a specific subject or with a group of subjects; and (3) a presence response module adapted to generate a system response to an identification of a specific subject or group of subjects. At least one of the indicators may indicate subject motion dynamics. The indicator may include at least one body part specific motion profile. The indicator may include at least one body part specific frequency coefficient.

According to further embodiments, the system may include a video acquisition sub-system and the presence response module may be adapted to generate signals intended to alter a security condition of a location associated with said system. A set of reference indicators may be associated with a specific banned or restricted group or set of subjects.

According to further embodiments, the system may include a video acquisition sub-system and the presence response module may be adapted to generate signals intended to alter an environmental condition of location associated with said system. A set of reference indicators may be associated with a family group member.

According to further embodiments, the system may include a video acquisition sub-system and the presence response module may be adapted to generate signals intended to trigger or alter content presented on a display associated with said system. A set of reference indicators may be associated with a specific demographic of people.

It should be understood by one of skill in the art that some of the functions described as being performed by a specific component of the system may be performed by a different component of the system in other embodiments of this invention.

The present invention can be practiced by employing conventional tools, methodology and components. Accordingly, the details of such tools, component and methodology are not set forth herein in detail. In the previous descriptions, numerous specific details are set forth, in order to provide a thorough understanding of the present invention. However, it should be recognized that the present invention might be practiced without resorting to the details specifically set forth.

In the description and claims of embodiments of the present invention, each of the words, “comprise” “include” and “have”, and forms thereof, are not necessarily limited to members in a list with which the words may be associated.

Only exemplary embodiments of the present invention and but a few examples of its versatility are shown and described in the present disclosure. It is to be understood that the present invention is capable of use in various other combinations and environments and is capable of changes or modifications within the scope of the inventive concept as expressed herein.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. An image based authentication system comprising:
receiving circuitry communicatively coupled to an image sensor and adapted to receive a series of images of a human, in which series of images at least one movement of the human is captured;
a biometric parameter extrapolation unit comprised of processing circuitry communicatively coupled to said receiving circuitry and configured to extrapolate, from the series of images, dynamic biometric parameter values of the movement, wherein dynamic biometric parameters of a given movement are parameters of one or more positions or movements of one or more body parts of the human during the given movement;
a data storage including reference profiles of one or more authorized individuals, wherein each reference profile includes one or more dynamic biometric parameter values or ranges associated with one of the one or more authorized individuals; and
an authentication unit comprised of processing circuitry configured to compare the extrapolated dynamic biometric parameter values of the movement to the one more dynamic biometric parameter values or ranges included in the reference profiles and authenticate an identity of the human based on the comparison.

2. The system according to claim 1, wherein said extrapolation unit uses skeletal models to extrapolate the dynamic biometric parameters by correlating elements of the skeletal models to the detected features and tracking positions of the correlated elements over the series of images.

3. The system according to claim 2, wherein the skeletal models are three dimensional models and correlating elements of the models includes correlating two dimensional projections of the three dimensional models to the detected features.

4. The system according to claim 1, wherein at least one of the dynamic biometric parameters is related to an authentication gesture.

5. The system according to claim 4, wherein the authentication gesture is a wave of a hand.

6. The system according to claim 1, wherein said biometric parameter extrapolation unit processing circuitry is further configured to extrapolate static biometric parameter values of the human, the reference profile further includes one or more static biometric parameter values associated with one of the one or more authorized individuals and said authentication unit processing circuitry is further configured to further compare the extrapolated static biometric parameter to the one more static biometric parameter values included in the reference profiles and factor the further comparison when authenticating the identity of the human.

7. A human monitoring system, comprising:
a video subsystem comprising one or more image sensors directed to one or more areas;
a video analytics subsystem comprising:
receiving circuitry communicatively coupled to said video subsystem and configured to receive images of the one or more areas from said video subsystem;
a data storage including biometric reference profiles, wherein each biometric reference profile includes a set of one or more dynamic biometric parameter values or ranges associated with an individual or human characterization; and
processing circuitry including processing logic configured to:
detect humans appearing in the received images;
identify features of the detected humans;
extrapolate, from the series of images, one or more dynamic biometric parameter values of at least one movement of at least one of the detected humans, wherein dynamic biometric parameter values of a given movement are parameters of one or more positions or movements of one or more body parts of a human during the given movement;
compare the extrapolated dynamic parameter values to one or more of the one or more dynamic biometric parameter values or ranges included in said reference profiles to identify a reference profile matching the extrapolated dynamic parameter values; and
provide an identification of the at least one detected human, as being the individual or having the human characteristic, associated with the identified reference profile.

8. The system according to claim 7, wherein said processing circuitry uses skeletal models to extrapolate the dynamic biometric parameters by correlating elements of the skeletal models to the detected features and tracking positions of the correlated elements over the series of images.

9. The system according to claim 8, wherein the skeletal models are three dimensional models and correlating elements of the models includes correlating two dimensional projections of the three dimensional models to the detected features.

10. The system according to claim 7, wherein at least one of the dynamic biometric parameters is related to a walking pattern.

11. The system according to claim 10, wherein the at least one of the dynamic biometric parameters is related to a spiral pattern of a point on a head of the detected humans.

12. The system according to claim 7, wherein said processing circuitry is further configured to extrapolate static biometric parameter values of the detected humans, each reference profile further includes one or more static biometric parameter values associated with the individual or human characterization and said processing circuitry is further configured to further compare the extrapolated static biometric parameter to the one more static biometric parameter values included in the reference profiles and factor the further comparison when identifying a matching reference profile.

13. The system according to claim 12, wherein the further comparison is performed prior to the comparison of dynamic biometric parameters and the comparison of dynamic biometric parameters is limited to reference profiles matching the extrapolated static biometric parameters.

14. The system according to claim 7, wherein comparing the extrapolated dynamic parameter values to one or more of the one or more dynamic biometric parameter values or ranges included in said reference profiles, to identify a reference profile matching the extrapolated dynamic parameter values, includes comparing multiple types of dynamic biometric parameter values to corresponding dynamic parameter values or ranges included in at least one of said reference profiles and aggregating the results of each of the comparisons to calculate a total match score between the extrapolated dynamic parameter values and the at least one of said reference profiles.

15. The system according to claim 14, wherein, when aggregating the results of each of the comparisons to calculate a total match score, includes applying a weight to the result of each of the comparisons based on the type of biometric parameter compared.

16. The system according to claim 15, wherein the weight applied to a given type of biometric parameter is dynamic and dependent on an external condition.

17. A human monitoring system, comprising:
a video subsystem comprising one or more image sensors directed to one or more areas;
a video analytics subsystem comprising:
receiving circuitry communicatively coupled to said video subsystem and configured to receive images of the one or more areas from said video subsystem;
a data storage including suspicious or interesting biometric reference profiles, wherein each biometric reference profile includes a set of one or more biometric parameter values or ranges; and
processing circuitry including processing logic configured to:
detect humans appearing in the received images;
identify features of the detected humans;
extrapolate, from the series of images, one or more biometric parameter values of at least one of the detected humans;
compare the extrapolated parameter values to one or more of the one or more biometric parameter values or ranges included in said reference profiles to identify a reference profile matching the extrapolated dynamic parameter values; and
provide an alert of the identified match.

18. The system according to claim 17, wherein said processing circuitry uses skeletal models to extrapolate the biometric parameters by correlating elements of the skeletal models to the detected features.

19. The system according to claim 18, wherein the skeletal models are three dimensional models and correlating elements of the models includes correlating two dimensional projections of the three dimensional models to the detected features.

20. The system according to claim 17, wherein at least one of the extrapolated biometric parameters relates to a pose of the at least one of the detected humans.
